(19) United States
(12) Patent Application Publication
(10) Pub. No.: US 2026/0327502 A1
(43) Pub. Date: Oct. 22, 2026

(54) System For Separation Of Gas, Liquid, And Solid Particles In A Material

(71) Applicant: BlueAlp Innovations B.V., Eindhoven (NL)

(72) Inventors: Teunis Christiaan VAN DER REE, Groot-Ammers (NL); Rik GOLDSMITS, Eindhoven (NL); Rob BRAAT, Eindhoven (NL); Sem HEIJMANS, Eindhoven (NL)

(73) Assignee: BlueAlp Innovations B.V., Eindhoven (NL)

(21) Appl. No.: 19/105,674

(22) PCT Filed: Aug. 25, 2023
(86) PCT No.: PCT/EP2023/073341

§ 371 Date: Feb. 21, 2025

(30) Foreign Application Priority Data
Aug. 31, 2022 (NL) 2032925
Aug. 31, 2022 (NL) 2032926
Aug. 31, 2022 (NL) 2032927
Aug. 31, 2022 (NL) 2032928
Aug. 31, 2022 (NL) 2032929

(51) Int. Cl. C10G 31/10; B01D 19/00; B01D 21/24; B01D 21/26; C10B 53/07; C10B 57/14; C10G 1/02; C10G 7/00

(52) U.S. Cl. CPC C10G 31/10; B01D 19/0057; B01D 21/2411; B01D 21/267; C10B 53/07; C10B 57/14; C10G 1/02; C10G 7/00; C10G 2300/1003

(57) ABSTRACT

There is described a process for pyrolysis of plastics material, the process comprising the steps of:
heating plastics material to pyrolysis temperature to provide a fluid stream of at least partially pyrolyzed material comprising liquid and gaseous hydrocarbons;
injecting the fluid stream of liquid and gaseous hydrocarbons into a gas-liquid separation vessel in which gaseous and liquid materials diverge, preferably under gravity;
releasing said gaseous material from the separation vessel for processing of the gaseous material to a hydrocarbon product;
amassing said liquid in a bottom portion of the separation vessel and subjecting the liquid to further pyrolysis;
   wherein the fluid stream of liquid and gaseous hydrocarbons is injected to generate a swirl or cyclonic fluid flow in the separation vessel.

### FIELD OF THE INVENTION

The invention generally concerns methods and apparatuses to process waste plastics by means of pyrolysis, as well as the products obtained thereby. More specifically the invention concerns methods and apparatuses for treatment of preheated streams of plastic and plastic derived hydrocarbons that are undergoing pyrolysis. More particularly, the invention concerns effective phase separation and/or completion of pyrolysis of plastic-derived hydrocarbons. Furthermore, the invention refers to a system for the separation of gas, liquid, and optionally solid particles in a material. The invention further refers to a method and system to crack long chained hydrocarbons and to separate the resulting products and in particular refers to a method and system to process plastics and polyolefins by means of cracking.

### BACKGROUND OF THE INVENTION

Large quantities of waste plastics are generated in the present society. While recycling of plastics is becoming ever more efficient and effective, it is still the case that much of the waste plastic cannot be effectively or efficiently recycled and is disposed of to landfill sites where it takes many years to degrade, or it may be lost to the environment where it can be damaging to ecosystems.

Plastic materials are however made of essentially useful compounds that can be used as is and/or converted for (re)use. For example, fuels such as diesel may be derived from waste plastics, or waste plastics may be converted to raw material suitable for synthesis of new materials, such as new plastics, other hydrocarbon materials, or similar. Materials recovered from waste plastics may be useful to at least partially replace hydrocarbons more traditionally obtained from natural gas or mineral oils.

The output of plastic-to-chemical plants typically includes light hydrocarbons (LHC), heavy hydrocarbons (HHC), char, and non-condensables (gases). Currently, LHC, HHC, or mixtures thereof, are the most desirable products, however, this is market dependent.

LHC and HHC fractions are required by industry to meet certain chemical and physical specifications such as vapor pressure, initial boiling point, final boiling point, Flash point, viscosity, cloud point and cold filter plugging point. Different qualities may be desired by different customers or end-uses, but it is important that plastic-to-chemical plants produce product of stable quality. The final qualities of the product fractions is controlled by a distillation column such as those well-known and commonly used in the petrochemical industry. It is desirable that the fractions are relatively pure such that light hydrocarbons fraction and heavy hydrocarbons do not contain large portions of high boiling point compounds. Such high boiling point compounds can increase cold filter plugging points, cloud point and are often unacceptable to pyrolysis oil purchasers.

In plastic-to-chemical plants, feedstock plastics, which may comprise for the most polyethylene and polypropylene for domestic sources, form the input. These plastics made up of very long chain hydrocarbons are then cracked into shorter chains, forming a wide spectrum of molecules with a variety of chain lengths. These mixtures can be distilled into various temperature-determined fractions as is known.

A known process in the art for converting waste plastic to, among other things diesel, is the thermochemical breakdown process of pyrolysis. Pyrolysis is the thermal decomposition of the waste plastics in an inert atmosphere. In effect, the long polymer chains of the plastic's polymers are cracked through heating, resulting in shorter hydrocarbon chains, which are generally more useful as a product.

Pyrolysis is a preferred method of performing thermochemical break down of waste plastic materials. Various attempts to provide technically and cost-effective pyrolysis of waste plastic have been attempted previously.

Technically useful results have been achieved by the technologies discussed in patent publications US2018/0010050 and WO2021053139, the contents of which publications are incorporated herein by reference.

US2018/0010050A1, discusses a method for recovering hydrocarbons from plastic wastes by pyrolysis without the use of catalysts, in particular polyolefin-rich waste. The process involves melting the plastic waste in two heating devices and mixing a stream derived from a cracking reactor with the incoming molten plastic waste of a first heating device. The heated, molten plastic is passed to a cracking reactor where the plastic materials are cracked. Subsequent thereto the cracked materials are distilled into diesel and low boilers.

WO 2021/053139 A1 which offers a number of advancements in relation to US2018/0010050A1, discusses, among other matters, a method for breaking down long-chain hydrocarbons from plastic-containing waste, comprising providing material containing long-chain hydrocarbons; heating a specific volume of the material containing long-chain hydrocarbons to a cracking temperature, at which cracking temperature the chains of hydrocarbons in the material start cracking into shorter chains; and for the specific volume having a temperature above the cracking temperature, exposing the specific volume to heat which is less than or equal to 50 °C above the temperature of the specific volume. After the specific volume of the material has been exposed to heat, WO 2021/053139 passes the partially cracked stream of molten plastic to a gas-liquid separation structure. The separation structure, also referred to as reactor, includes a separation zone containing a gas-liquid phase boundary, and a settling zone for heavy hydrocarbons and/or solid carbon, as well as potentially other solids such as aluminium, sands, dirt, etc., to accumulate.

Although good results have been achieved based on the above technologies, there remains room for further improvement, for example it would be useful to provide systems and processes that are more versatile than previously attempted systems.

EP 2 876 146 B1 discusses tested technology in which a process for recovering hydrocarbons from polyolefin plastic recyclables by means of pyrolytic cracking comprises: introducing the plastic recyclables into a mixing vessel under inert gas and mixing with diesel oil, removing water vapor in a first heating zone, removing acidic gases in a second heating zone, liquefying those not yet melted Plastic recyclables in a third heating zone, cracking of the plastic recyclables in a cracking reactor at approx. 400 degrees centigrade, partial condensation to prevent the discharge of paraffins, fractionation of the cracked products.

While the present invention has a general aim the overall system improvement of such pyrolysis processes and apparatuses, aspects of improvement may preferably include one or more of the following.

In an aspect it is an object of the present invention to provide alternatives, and preferably improvements for pyrolysis processes and apparatuses. These may address the separation of gas, liquid and solid particles in a cracking stream of plastic and/or the system for cracking of long chained hydrocarbons. It is also an object of the present invention to provide an improved method for breaking down long chained hydrocarbons.

In an aspect of the invention, it may be useful to reduce or limit char formation in the vessel where pyrolyzed gaseous hydrocarbons are separated from liquid, partially-pyrolyzed plastic material.

In another aspect of the invention, it may be useful to achieve better control of product fractions that are sent to distillation, and which fractions are eventually distilled. For example, to achieve more commercially useful ratios of non-condensables, light hydrocarbon fractions, and heavy hydrocarbon fractions in the product streams.

In another aspect of the invention, it may be desirable to improve reliability of processes.

In another aspect of the invention, it may be desirable to improve or limit downtime of the system.

In another aspect of the invention, it may be advantageous to expand or diversify the product streams available for production by the pyrolysis process, for example, for production of heavier fractions such as paraffins at controllable quantities.

It is a non-limiting object of the present invention to provide efficient, versatile, and/or robust processes and apparatuses for conversion of waste plastic to useful product streams, e.g. non-condensable gasses, light hydrocarbons, heavy hydrocarbons, paraffins, bitumen, tar and other similar derivable fractions. In this respect the invention may address, for example, one of more of the foregoing problems or at least provide the technical arts with a useful choice.

Attempts to achieve effective pyrolysis of waste plastics have been previously made.

An example is discussed in patent publication WO11077419 A1 referring to a process for treating waste plastics, in which plastic is melted and then pyrolyzed in an oxygen-free atmosphere in a jacket-heated pyrolysis vessel to provide pyrolysis gases. The pyrolysis gases upwardly flow via a pipe directly linking the pyrolysis chamber to a contactor vessel, into contact with plates in the contactor vessel so that some long chain gas components condense. The condensed liquid is directly returned by downward flow through the same pipe, to the pyrolysis zone. The condensed liquid is then reheated within the pyrolysis zone and further pyrolyzed. The short chain gas components exit the contactor in gaseous form and proceed to distillation.

It is explained in WO11077419 A1 that as a batch ends, increased load on a pyrolysis chamber agitator indicates that char drying is taking place, and that the process is ending. The pyrolysis chambers are then purged by operating double-helical agitator blades in reverse to remove char, and nitrogen is passed up through the contactor and out directly to thermal oxidisers to flush any remaining hydrocarbons, during which phase the pyrolysis vessel and contactor are isolated from the rest of the system. Such a process and system can be problematic and suboptimal. For example, the inclusion of an agitator in the pyrolysis chamber, as well as jacketed direct heating of the pyrolysis chamber, is complex yet necessary. The system also makes use of a specific type of jacket-cooled contactor with cooled contactor baffle plates that are sloped and comprise apertures, to give direct return of condensed hydrocarbons from the contactor to the pyrolysis chamber via the same pipe by which pyrolysis gases entered the contactor. This can be complex; the pyrolysis process leads to batch completion with a dry char (carbon) product; and purging associated with extended downtime of pyrolysis reactors.

There are prior attempts in which a partial condenser has been arranged directly on top of a pyrolysis vessel to return heavy hydrocarbons for further cracking. Some of these attempts have been found to be less versatile, robust, and efficient than is optimal. Without being bound by theory, and by identification through technical investigation, it may be that the condensed liquid returning from the partial condenser directly into a pyrolysis reactor vessel can lead to temperature inconsistencies and heat loss in a pyrolysis zone, requiring complex heat input at the pyrolysis zone, with possible hot spots, charring, complex agitation, and/or energy loss. Provision of a process and system that suffers less from such disadvantages may be desirable.

Another example is discussed in CH708681A1, which refers to a process for recovering hydrocarbons from polyolefin plastic recyclables by means of pyrolytic cracking. Plastic recyclables are introduced into a mixing vessel under inert gas and mixing with diesel oil, removing water vapor in a first heating zone, removing acidic gases in a second heating zone, liquefying those not yet melted plastic recyclables in a third heating zone, cracking of the plastic recyclables in a cracking reactor at about 400 °C, partial condensation to prevent the discharge of paraffins, and fractionation of the cracked products.

The partial condenser in CH708681A1 is separate and spaced from the pyrolysis reactor, with a communicating pipe leading pyrolyzed gases from the pyrolysis reactor to the partial condenser. The partial condenser is adjusted so that heavy hydrocarbons that are not of the desired product character condense and are led back into a third heating zone, via a separate pipe, where they can be further cracked. The additional cracking loop reduces the inclusion of overly heavy hydrocarbons in the product.

Attempts to implement related concepts to those disclosed in CH708681A1 were found to workably result in product but showed some instability in pyrolysis and inefficiencies, for example, requiring complex heating in the pyrolysis zone. In addition, the system of CH708681A1 may be complex to implement because of differential pressures between the partial condenser and the heating zone to which the heavy hydrocarbons are returned.

Other attempts have included U.S. Pat. No. 10,160,920 BB with a sequential cracking process for the thermal cracking of a hydrocarbon feedstock in a cascade of cracking units; US2007227874 AA discussing a method for recovering fractional hydrocarbons from recycled plastic; and U.S. Pat. No. 5,580,443 A which discusses a process for thermally cracking a low-quality feed stock containing a considerable proportion of heavy fractions such as high-boiling fraction.

All references, including any patents or patent applications cited in this specification are hereby incorporated by reference. No admission is made that any reference constitutes prior art.

### SUMMARY

While the invention is defined in the independent claims, further aspects of the invention are set forth in the dependent claims, the drawings, the following description and the clauses.

According to an aspect of the invention there is provided a process for pyrolysis of plastics material, the process comprising the steps of:
heating plastics material to pyrolysis temperature to provide a fluid stream of at least partially pyrolyzed material comprising liquid and gaseous hydrocarbons;
injecting the fluid stream of liquid and gaseous hydrocarbons into a gas-liquid separation vessel in which gaseous and liquid materials diverge, preferably under gravity;
releasing said gaseous material from the separation vessel for processing of the gaseous material to a hydrocarbon product;
amassing said liquid in a bottom portion of the separation vessel and subjecting the liquid to further pyrolysis;
wherein the fluid stream of liquid and gaseous hydrocarbons is injected to generate a swirl or cyclonic fluid flow in the separation vessel.

The swirl or cyclonic flow may assist in achieving efficient phase separation of the stream with the denser liquid being driven to the periphery and the gas rising upwardly. It may further assist is heat distribution and/or solid particulates sinking effectively within the liquid body.

Liquid and entrained solids (and/or solids such a carbon generated in pyrolysis) may so collect at the bottom portion of the separator vessel where it can be further processed and or separated.

The injection of the fluid stream is preferably done below the level of an accumulated body of liquid in the separator vessel. This may assist in generating a swirling or cyclonic effect in the amassed liquid body.

The fluid stream of liquid and gaseous hydrocarbons is preferably injected into the gas-liquid separation vessel substantially tangentially to an inner surface of the separation vessel, preferably wherein the separation vessel has a substantially circular cross-section at least at a point of injection. This may further assist in generating a swirling or cyclonic effect in the amassed liquid body.

Portions of the liquid material amassed in the separation vessel may be removed from the separation vessel e. g by suction or pump, reheated to a pyrolysis temperature and returned to the separation vessel as a second incoming fluid stream comprising liquid and gaseous hydrocarbons. This may assist in a reducing of lack of any need for heating internal to the separation vessel to achieve pyrolysis. The second fluid stream may preferably be injected into the gas-liquid separation vessel separately to the first stream or alternatively jointly.

In an aspect of the invention there is provided an apparatus for pyrolyzing waste plastics to one or more hydrocarbon products, preferably at least one or more liquid hydrocarbon products, the apparatus comprising:
a heating device, preferably a heat exchanger, for receiving and heating waste plastic to pyrolysis temperature;
a separator vessel downstream of the heating device, wherein the separator device comprises:
an inlet arranged to receive pyrolysis temperature, gaseous and liquid plastics waste from the heating device,
an upper outlet for exit of gaseous material; and
a lower outlet for exit of liquid material;
wherein the inlet is arranged to inject the gaseous and liquid plastics waste from the heating device to generate a swirl or cyclonic fluid flow in the separation vessel.

Inlet(s) for hot, liquid plastics waste material are preferably arranged to inject substantially tangentially to an inner surface of the separation vessel, and the separation vessel has a substantially circular cross-section at least at a point or level of injection. This may assist in achieving swirl or cyclone.

The separation vessel is preferably elongate and vertically arranged for pyrolyzed gaseous and liquid materials to diverge under gravity, pyrolyzed gaseous material passing upwardly to the upper outlet and liquid material passing downwardly.

In an aspect of the invention there is provided a process for pyrolysis of plastics material, the process comprising the steps of:
heating plastics material to pyrolysis temperature to provide a fluid stream of at least partially pyrolyzed material comprising liquid and gaseous hydrocarbons;
passing the fluid stream of liquid and gaseous hydrocarbons into a gas-liquid separation vessel in which gaseous and liquid materials diverge, preferably under gravity;
releasing said gaseous material from the separation vessel for processing of the gaseous material to a hydrocarbon product;
amassing said liquid in a bottom portion of the separation vessel and subjecting the liquid to further pyrolysis;
withdrawing a portion of said amassed liquid material from the separation vessel, heating said withdrawn liquid to pyrolysis temperature and returning it to the separation vessel as a fluid stream comprising liquid and gaseous hydrocarbons;0
wherein the amassed liquid is withdrawn via an outlet internal to the separation vessel, preferably an outlet substantially radially central within the separation vessel.

This may assist in achieving removal of liquid from the separation vessel, possibly for reheating, that is relatively low in solid particle content as compared to previous attempts to remove liquid at the inner wall. Preferably the outlet for withdrawal of the amassed liquid is positioned in a generally central portion of a swirl or cyclonic flow created in the vessel where a still zone, with little liquid motion may be emergent.

A shroud may be provided at least partially radially encompassing the liquid outlet, preferably partially or fully submerged in the amassed liquid, which may assist in excluding solid particulates and or exacerbating a still zone. Preferably the shroud at least partially isolates the liquid outlet from a radially outer cyclonic or swirling flow in the separation vessel.

The amassed liquid outlet may preferably comprise a vertically arranged cylinder, preferably of circular cross-section, having an opening at its upper end and an opening at its and lower end. The opening at the upper end is preferably smaller than the opening at the lower end, which may assist in effective liquid removal yet allow upward gas bubble escape to the gas zone in the vessel.

In an aspect of the invention there is provided an apparatus for pyrolyzing waste plastics to one or more hydrocarbon products, preferably at least one or more liquid hydrocarbon products, the apparatus comprising:
a heating device, preferably a heat exchanger, for receiving and heating waste plastic to pyrolysis temperature;
a separator vessel downstream of the heating device, wherein the separator device comprises:
an inlet arranged to receive pyrolysis temperature, gaseous and liquid plastics waste from the heating device,
an upper outlet for exit of gaseous material; and
a lower outlet for exit of liquid material;
wherein the lower outlet for exit of liquid material is positioned internally in the separation vessel, preferably substantially radially centrally.

It is preferable in the apparatus that the inlet is arranged to inject the gaseous and liquid plastics waste from the heating device substantially tangentially to an inner surface of the separation vessel, preferably wherein the separation vessel has a substantially circular cross-section at least at a point or level of injection.

The separation vessel of the invention is preferably elongate and vertically arranged. This may assist in the pyrolyzed gaseous and liquid materials diverging under gravity, pyrolyzed gaseous material passing upwardly to the upper outlet and liquid material passing downwardly.

The liquid outlet is preferably located below an operational liquid level of the separation vessel and is preferably submerged in use.

In an aspect of the invention there is provided an apparatus for pyrolyzing waste plastics to one or more hydrocarbon products, preferably at least one or more liquid hydrocarbon products, the apparatus comprising:
a heating device, preferably a heat exchanger, for receiving and heating waste plastic to pyrolysis temperature;
a separator vessel downstream of the heating device, wherein the separator vessel comprises:
an inlet arranged to receive pyrolysis temperature, gaseous and liquid plastics waste from the heating device,
an upper outlet for exit of gaseous material; and
a hollow body with a bottom portion that is substantially conical;
   wherein the substantially conical bottom portion has an opening angle is from about 30° to about 70°, preferably from about 50° to about 70°, preferably from about 55° to about 65°, more preferably about 60°. The angle of the cone may assist in effective sinking of particulate materials into a high solids concentration portion of the liquid, yet while minimizing blocking of a lower outlet.

In the various aspects of the invention, the separation vessel has an inner surface, preferably an inner surface of the lower cone portion, with a surface roughness less than Ra 25 μm, preferably less than Ra 15 μm, more preferably less than Ra 12 μm, even more preferably less than Ra 10 μm, even more preferably less than Ra 6 μm. A smooth surface may assist in effective sinking of particulates as well as reducing fouling.

In an aspect of the invention there is provided a process for pyrolysis of plastics material, the process comprising the steps of:
heating plastics material to pyrolysis temperature to provide a fluid stream of at least partially pyrolyzed material comprising liquid and gaseous hydrocarbons, and solid carbon particles;
passing the fluid stream into a gas-liquid separation vessel in which gaseous and liquid materials diverge, preferably under gravity;
releasing said gaseous material from the separation vessel for processing of the gaseous material to a hydrocarbon product;
amassing said liquid, including entrained solid carbon particles in a bottom portion of the separation vessel and subjecting the liquid to further pyrolysis with further generation of solid carbon particles;
settling said solid carbon particles to a bottom portion of the separation vessel, wherein the bottom portion is substantially conical, and the substantially conical bottom portion has an opening angle is from about 30° to about 70°; and
withdrawing at least a portion of a hydrocarbon and solid carbon particle mixture from the bottom conical portion.

In an aspect of the invention there is provided a process for pyrolysis of plastics material, the process comprising the steps of:
heating plastics material to pyrolysis temperature to provide a fluid stream of at least partially pyrolyzed material comprising liquid and gaseous hydrocarbons;
passing the fluid stream of liquid and gaseous hydrocarbons into a gas-liquid separation vessel in which gaseous and liquid materials diverge, preferably under gravity;
releasing said gaseous material from the separation vessel for processing of the gaseous material to a hydrocarbon product;
amassing said liquid in a bottom portion of the separation vessel and subjecting the liquid to further pyrolysis; and
determining a liquid level in the separation vessel by radar measurement, radioactive measurement, temperature measurement, mass measurement, and/or pressure measurement.

Preferably the liquid level in the separation vessel is controlled by adjustment of a rate of pyrolysis, preferably by temperature control. The liquid level may alternatively or simultaneously be controlled by rate of introduction of a fresh feed.

Maintaining a predetermined level in the separation vessel may assist in achieving efficient cracking, desired product output, and may protect operational equipment such as (centrifugal) pumps from damage. Providing a predetermined liquid level in the separation vessel may also assist in efficient and/or safe start up procedures for a system.

In an aspect of the invention there is provided an apparatus for pyrolyzing waste plastics to one or more hydrocarbon products, preferably at least one or more liquid hydrocarbon products, the apparatus comprising:
a heating device, preferably a heat exchanger, for receiving and heating waste plastic to pyrolysis temperature;
a separator vessel downstream of the heating device, wherein the separator vessel comprises:
an inlet arranged to receive pyrolysis temperature, gaseous and liquid plastics waste from the heating device,
an upper outlet for exit of gaseous material; and
a liquid level measurement system for determining liquid level in the separation vessel, the liquid level measurement system comprising one, more or all of the devices chosen from the group of radar measurement, radioactive measurement, temperature measurement, mass measurement, and differential pressure measurement.

In an aspect of the invention there is provided a process for pyrolysis of plastics material, the process comprising the steps of:
heating plastics material to pyrolysis temperature to provide a fluid stream of at least partially pyrolyzed material comprising liquid and gaseous hydrocarbons, and solid carbon particles;
passing the fluid stream into a gas-liquid separation vessel in which gaseous and liquid materials diverge, preferably under gravity;
releasing said gaseous material from the separation vessel for processing of the gaseous material to a hydrocarbon product;
amassing said liquid, including entrained solid carbon particles in a bottom portion of the separation vessel and subjecting the liquid to further pyrolysis with further generation of solid carbon particles;
settling said solid carbon particles to a bottom portion of the separation vessel; and
withdrawing at least a portion of a hydrocarbon and solid carbon particle mixture from the bottom portion of the separation vessel, and recirculating said hydrocarbon and solid carbon particle mixture to said bottom portion.

Recirculation of the mixture may assist in providing a more effective particle-rich-liquid expulsion and hence provision of a more robust and low-maintenance apparatus and process, reducing or preventing gelling, coalescence, coagulation or similar in the dense material. This may assist in preventing blockage of the separation vessel, and may assist in-process carbon removal.

Preferably in the process, the step of withdrawing and recirculating said hydrocarbon and solid carbon particle mixture, the hydrocarbon and solid carbon particle is withdrawn from the bottom of the separation vessel and is recirculated and injected into the separation vessel at a position, wherein that position is above the bottom withdrawal point and below the liquid level in the separator vessel, preferably below an outlet for withdrawing a portion of said amassed liquid material that has a lower concentration of solid particles, from the separation vessel. This circulates high concentration material into a lower concentration zone, assisting in reducing blockages.

It is preferable that a characteristic of the withdrawn material be measured, for example a characteristic indicative of a coke, char or solid particle concentration or particle size. This may be done by density analysis, turbidity analysis, viscosity analysis, spectrometer analysis, radioactive analysis and/or ultrasound analysis.

Preferably the withdrawn solids containing liquid may be heated prior to being returned to the separation vessel.

In an aspect there is provided an apparatus for pyrolyzing waste plastics to one or more hydrocarbon products, preferably at least one or more liquid hydrocarbon products, the apparatus comprising:
a heating device, preferably a heat exchanger, for receiving and heating waste plastic to pyrolysis temperature;
a separator vessel downstream of the heating device, wherein the separator device comprises:
an inlet arranged to receive pyrolysis temperature, gaseous and liquid plastics waste from the heating device,
an upper outlet for exit of gaseous material;
a carbon outlet at the base of the separator vessel for withdrawal of a hydrocarbon and solid carbon particle mixture from a bottom portion of the separation vessel;
one or more recirculation nozzles positioned at the bottom portion of the separation vessel for injection of at least a portion of said withdrawn mixture to the separation vessel.

The determine a characteristic of the removed liquid, the apparatus may comprise a sample point or station for determination of a characteristic of the withdrawn mixture, preferably a characteristic indicative of a concentration or size of solid carbon particles in said mixture, preferably including at least one sensor selected from a density sensor, a turbidity sensor, a flow sensor, a spectrometer, a radioactive sensor, and/or an ultrasound sensor. Monitoring may assist in controlling the process and determining when cleaning or maintenance is required.

In aspects, it may be useful to reduce or limit char formation in the vessel where pyrolyzed gases are separated from liquid, partially-pyrolyzed plastic material. In that respect, it may be useful to reduce, limit or avoid, direct heating of such a vessel, for example heating of the vessel wall, or inclusion of a heating element (such as a heating coil) within such a vessel. The preferred separator vessel of the present invention is not heated, e.g. no jacket heater or internal heating element is provided. The introduced stream of molten waste plastics may be provided already at pyrolysis temperature and does not require additional heating in the separation vessel. In some preferred embodiments, liquid, partially-pyrolyzed plastic material collected in the separation vessel is controllably removed from the separation vessel, preferably by pump, and reheated, preferably in a heat exchanger, to pyrolysis temperatures prior to being returned to the separation vessel, optionally together with fresh feed. Long-chain hydrocarbons in the removed liquid may thus be subjected to further pyrolysis and broken down to shorter-chain hydrocarbons, eventually exiting via the partial condenser.

Waste plastic feedstock for the invention may preferably comprise polyethylene and/or polypropylene plastics. Preferably the sum of polyethylene and polypropylene in the feedstock is at least 50 wt. % by weight of the feedstock, more preferably at least 60 wt. %, still more preferably at least 75 wt. %, most preferably at least 90 wt. %. These materials represent a large portion of domestic plastic waste and are treatable by pyrolysis. The preferred plastic for the feedstock is polyethylene or polypropylene

The feedstock may also comprise polyvinylchloride plastics, however, the level of PVC may preferably be limited to less than 10 wt. %, preferably less than 5 wt. %. PVC may be present at greater than 1 wt. %, more preferably greater than 5 wt. %. An effective absence of PVC in the feedstock may be preferred.

The feedstock may also comprise polyethylene terephthalate plastics, preferably greater than 3 wt. % of polyethylene terephthalate plastics, more preferably greater than 4 wt. %. The feedstock preferably comprises maximally 20 wt. % PET plastic. Preferably the content of polyethylene terephthalate plastics is maximally 10 wt. %, more preferably 5 wt. %.

The feedstock may comprise up to 100 wt. % polystyrene plastics. In embodiments, the feedstock may comprise at least 5 wt. %, more preferably 20 wt. %, more preferably 50 wt % polystyrene.

Pyrolysis temperatures may vary within a limited range dependent upon factors such as feedstock makeup and operating pressures, preferably the plastics material is heated to a pyrolysis temperature of 360 °C or more, about 390 °C or more, more preferably about 400 °C or more, up to about 450 °C, although higher temperatures up to about 500 °C or about 550 °C may be implemented. The plastic pyrolysis may start from about 360 °C, and so such temperatures may also be contemplated. Pyrolysis is, however, more significant at or above about 390 °C, which may allow for a more economically attractive process.

The term “pyrolysis zone” as used herein refers to zones in which materials that are processed by the process or system (e.g. waste plastic or the derivates thereof generated by pyrolysis in the process or system) are at pyrolysis temperatures, for example at temperatures at or above 360 °C, more preferably at temperatures at or above 390 °C, still more preferably at or above 400 °C. Pyrolysis zones are preferably those zones in the process or system in which the processed materials are at temperatures from about 360 °C to about 550 °C, more preferably from about 390°C to about 500 °C, still more preferably from about 400 °C to about 500 °C. The process and system may comprise pyrolysis zones of different activity. For example, there may be primary pyrolysis zones in which the majority of pyrolysis occurs, which are preferably at temperatures above 390 °C, and second pyrolysis zones in which the temperatures are above 360 °C but below 390 °C. Pyrolysis zones are zones in the system, process of apparatus why pyrolysis occurs, or conditions for pyrolysis are generated.

The pyrolysis is, as commonly understood, carried out in the absence of oxygen, most preferably under an inert atmosphere. Nitrogen gas may provide an inert atmosphers. Before start-up the system may purged with nitrogen gas to provide at least an initial inert atmosphere.

The gas phase may preferably a composed of pyrolysis gases with oxygen being substantially absent, optionally including nitrogen.

The operating pressure of a separator vessel is preferably above ambient to ensure that ambient air does not enter the system. The pressure may be from 1 bar abs. to 5 bar abs., 1 bar abs. to 3 bar abs., 1 bar abs. to 2 bar abs., or 1 bar abs. to 1.5 bar abs, or 1 bar abs. to 1.05 bar abs.

The invention preferably produces one or more hydrocarbon products, preferably wherein the hydrocarbon products include one or more of butane, propane, kerosene, diesel, fuel oil; light distillates, such as LPG, gasoline, naphtha, or mixtures thereof, middle distillates such as kerosene, jet fuel, diesel, or mixtures thereof; heavy distillates and residuum such as fuel oil, lubricating oils, paraffin, wax, asphalt, or mixtures thereof. Hydrocarbon products may be saturated, unsaturated, straight, cyclic or aromatic. Further product may include non-condensable gases, comprising methane, ethane, ethene and/or other small molecules. The products may be a source of feedstock for steam crackers of the manufacture of plastics.

The term “non-condensables” or “non-condensable gases” as variously referred to, identifies hydrocarbon fractions that are too volatile to condense in the distillation section, and that may, preferably will, exit the process as a gas. It is generally considered that non-condensable hydrocarbons in the pyrolysis process have from about 1 to about 7 carbon atoms. The non-condensables may include hydrocarbons that are saturated, unsaturated, straight, cyclic and/or aromatic.

The term “light hydrocarbons” or “LHC” as variously referred to, identifies hydrocarbon fractions that are condensable in the process and so obtainable as a liquid, yet which comprise short-chain molecules. It is generally considered that LHCs in the pyrolysis process have from about 3 to about 8 carbon atoms, possibly with some smaller portion of C2 molecules and/or C10 molecules. The LHCs may include hydrocarbons that are saturated, unsaturated, straight, cyclic and/or aromatic.

The term “heavy hydrocarbons” or “HHC” as variously referred to, identifies hydrocarbon fractions that are condensable in the process and so obtainable as a liquid, with generally longer chain composition than LHCs. It is generally considered that HHCs in the pyrolysis process have at least about 7 carbon atoms (possibly with some smaller portion of C6 molecules), preferably up to about 35 carbon atoms. Preferred ranges may include low range products of about 7 to about 20 carbon atoms, possibly with some smaller portion of C6 and/or C21 molecules. For the low range product, the final boiling point of the HHC may be about 430 °C. Another preferred range may include medium range products of from about 8 to about 28 carbon atoms. For the medium range product, the final boiling point of the HHC may be about 450 °C. Another preferred range may include high range products from about 10 to about 35 carbon atoms. For the high range product, the final boiling point of the HHC may be about 550 °C. HHCs may include hydrocarbons that are saturated, unsaturated, straight, cyclic and/or aromatic.

It will be appreciated by the skilled reader dealing with petrochemicals, that there may be some variation in the boundary between non-condensables, LHC and HHC in a distillation process. Overlap and/or variation may be dependent, inter alia, upon chosen temperature, pressures and flow settings, and product specification may be adjusted to accommodate desired product qualities.

### BRIEF DESCRIPTION OF THE DRAWINGS

The features and advantages of the invention will be appreciated upon reference to the following drawings, in which:

FIG. 1 shows an assembly for cracking long chained hydrocarbons;

FIG. 2 shows an embodiment of a separation vessel, partial condenser and reboiler of FIG. 1 in greater detail;

FIG. 3 shows an embodiment of a separator vessel;

FIG. 4 shows a side elevation of the separator vessel of FIG. 3;

FIG. 5 shows a side elevation of the separator vessel of FIG. 3;

FIG. 6 shows a side elevation of the separator vessel of FIG. 3;

FIG. 7 shows a cross section of the separator vessel of FIG. 3;

FIG. 8 shows a top view of the separator vessel of FIG. 3;

FIG. 9 shows an underside of the separator vessel of FIG. 3;

FIG. 10 shows an enlarged partial view of a lower portion of the separator vessel of FIG. 3;

FIG. 11 schematically illustrates a reheating recycling loop for a separation vessel;

FIG. 12 shows an enlarged partial view of a lower portion of the separation vessel of FIG. 3;

FIG. 13 schematically illustrates a lower portion of a separation vessel provided with an inner liquid withdrawal outlet;

FIG. 14 schematically illustrates a lower portion of a separation vessel provided with an inner liquid withdrawal outlet;

FIG. 15 schematically illustrates a lower portion of a separation vessel provided with an inner liquid withdrawal outlet and an internal shroud;

FIG. 16 schematically illustrates a liquid flow pattern about the shroud of FIG. 15.

FIG. 17 schematically illustrates a lower portion of a separation vessel provided with a carbon and/or bitumen circulation loop;

FIG. 18 schematically illustrates a separation vessel provided with a liquid level temperature-sensor;

FIG. 19 schematically illustrates a separation vessel provided with a liquid level radiation-sensor; and

FIG. 20 schematically illustrates a separation vessel provided with load sensors.

### DESCRIPTION AND ILLUSTRATIVE EMBODIMENTS

It will be appreciated that for simplicity and clarity of illustration, where considered appropriate, reference numerals may be repeated among the figures to indicate corresponding or analogous elements or steps. In addition, numerous specific details are set forth to provide a thorough understanding of the embodiments described herein. However, it will be understood by those of ordinary skill in the art that the embodiments described herein may be practiced without these specific details. Furthermore, this description is not to be considered as limiting the scope of the embodiments described herein in any way, but rather as merely describing the implementation of the various embodiments described herein. The following is a description of certain embodiments of the invention, given by way of example only and with reference to the drawings.

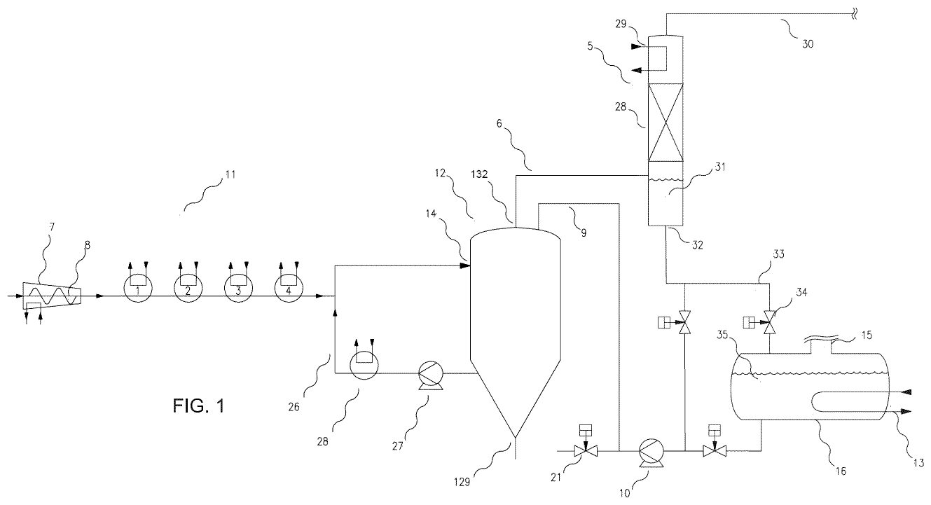

FIG. 1 shows an apparatus comprising a heating device 11 and a separation vessel 12. The heating device 11 is in communication with the separation vessel 12 to feed fluids (liquids and gases) into the separation vessel 12. More specifically, the heating device 11 feeds fluids containing (partially) cracked hydrocarbons in both gaseous and liquid states into the separation vessel 12 at pyrolysis temperatures.

In some embodiments a feeding device 7 is arranged to fill material containing long chained hydrocarbons such as waste plastics as discussed, into the heating device 11. In some embodiments the feeding device comprises an effector 8 for heating and/or forwarding the material containing long chained hydrocarbons. In some embodiments the effector is a screw auger 8 arranged to forward, and preferably also heat, the material containing long chained hydrocarbons. In some embodiments the screw auger 8 moves the material, and internal friction in the material causes the material to heat up and to melt. In further embodiments the feeding device 7 comprises a heating device such as an electrical heater or a heating device perfused by a heating medium such as thermal oil. The feeding device 7 drives the material containing long chained hydrocarbons to the heating device 11.

A substantial portion of the solid particulates will result from the pyrolysis reaction, and it is generation of char or coke particles as is common to pyrolysis. Other particulates may be present due to impurities in the initial plastic feed stream to the process, such as metal particles, and other detritus including for example organic matter. In the illustrated embodiment, four heating zones are illustrated. Each of the heating zones 1, 2, 3, 4, may be a heat exchanger, preferably a tube in shell heat exchanger. The heating zones 1, 2, 3, 4 provide a flow path for the plastics material containing long chained hydrocarbons. The heating zones 1, 2, 3, 4 continuously or gradually increase the exposure temperature along the flow path. Heating is preferably done gradually to reduce or avoid char formation through excessive temperature differentials.

The heating device 11 heats and melts plastic material feedstock, raising its temperature to a pyrolysis temperature. Cracking may start in any of the heating zones 1, 2, 3, 4, with most cracking in the heating zones preferably occurring in heating zone 4, zone 4 being the hottest heating zone of the four. Pyrolysis temperatures may be 360 °C or greater, more preferably 390 °C or greater, preferably 395 °C or greater, preferably 400 °C or greater, more preferably 410 °C or greater. A pyrolysis temperature may be in the range of 360-550 °C more preferably 390-450 °C.

The molten, partially pyrolyzed plastic material exits heating zone 4 at a pyrolysis temperature and passes into separation vessel 12 via separation vessel inlet 14.

In the separation vessel 12, incoming cracked gases and liquid separate. Gases will rise and exit to a partial condenser 5, and liquids will fall to the bottom of the separation vessel 12.

A recycling loop 26 is provided to remove liquid, partially-pyrolyzed plastic material collected in the separation vessel 12 by way of pump 27. The removed liquid is reheated to a pyrolysis temperature by the heat exchanger 28, and then returned to the separation vessel 12, in the illustrated case together with fresh feed. This recycle loop 26 increases the residence time for long-chain hydrocarbons at pyrolysis temperature so that they are subjected to further pyrolysis and broken down to shorter-chain hydrocarbons, eventually exiting via the partial condenser 5.

The recycle loop 26 provides for reheating and reintroduction of heat to the separation vessel 12, such that the separation vessel 12 remains at a pyrolysis temperature. The heat is carried into the separation vessel 12 by the incoming reheated stream of material provided by the recycle loop 26.

In the illustrated, preferred embodiment, the separation vessel 12 is unheated, the term “unheated” meaning that the separation vessel 12 is not heated by any source other than heat carried by incoming heated material, for example, heated material entering the inner volume of the separation device from a heating device such as the heating device 11 or another heating device as may be provided on of in a recycling or return loop.

It has been found to be useful to avoid provision of heating means on or in the separation vessel, as may be found in some prior attempts. This may assist in reducing char formation in the separation vessel 12 and reduces or avoids requirements for special agitation means. For example, it has been found in prior attempts that an internal heater, such as a heating coil, can cause charring of pyrolyzing material at the surface of the heating element. That char may represent loss of product and may collect on the heating element requiring downtime for cleaning and maintenance. The same may be true in cracking reactor type vessels wherein the wall of the vessel is heated to bring or maintain the treated material at pyrolysis temperature. Charring may occur at the inner surface of the cracking reactor wall resulting in the need for complex mixing, cleaning and downtime. None the less, use of direct heating of the separator vessel, e.g. via a jacket or internal heat exchanger or heating coil, is not excluded from use in some embodiments or aspects of the invention and may be employed to a supply all or part of the heat requirement to the pyrolysis zone(s).

In the illustrated, preferred embodiment, the separation vessel 12 is not provided with an agitator, such as a stirrer or auger. Without wishing to be bound by theory, it is believed that inclusion of an auger or similar stirring device to agitate liquid in the separator vessel may be disadvantageous because it introduces complexity; forms a surface area upon which carbon/char can accumulate so reducing efficiency and requiring maintenance; and may interrupt flow patterns imparted by injection or materials. However, optionally as may be useful to improve mixing inside the separation vessel 12, an agitator inside the separation vessel 12 may be provided or is not excluded from some embodiments and aspects.

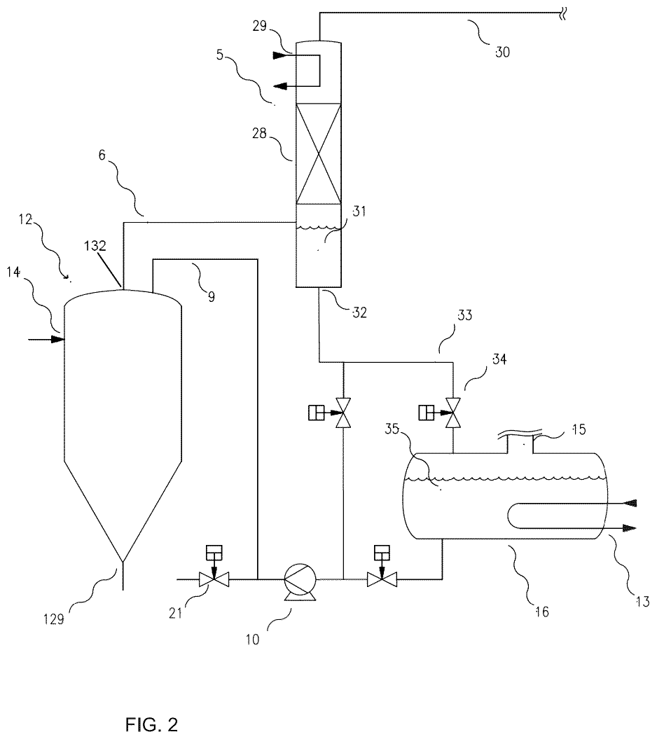

The combination of the separation vessel 12, a partial condenser 5 and a reboiler 16 is illustrated more clearly in FIG. 2.

At the point of entering the separation vessel 12 via inlet 14 the plastics material is undergoing pyrolysis because it is at a pyrolysis temperature. The cracking of the plastic material results in generation of a wide spectrum of substances with a wide range of boiling points. The plastics material exiting the heating device 11 and entering the separation vessel 12 via inlet 14 comprises at least both gaseous and liquid components, the liquid component comprises at least partially cracked plastics material, possibly consists substantially of partially cracked plastics material. The liquid component may also comprise molten, uncracked plastic material. The plastics material exiting the heating device 11 and entering the separation vessel 12 via inlet 14 may additionally comprise silt and other solid detritus, for example, sand, aluminium, or other metal particles.

The illustrated separation vessel 12 is elongate and arranged substantially vertically. Non-vertical arrangements may also be envisioned, such as slanted or horizontal. Pyrolyzed gaseous material rises in the separation vessel 12 and liquid (partially) pyrolyzed material falls under gravity. In this manner, gaseous and liquid materials diverge and so separate in the separation vessel 12.

The gaseous hydrocarbon materials rising in the separation vessel 12 discharge via upper outlet 132 and pass via line 6 to the partial condenser 5. Partial condenser 5 is remote from the separation vessel 12 and is positioned downstream from the separation vessel 12. It is in fluid communication with the separation vessel 12 via the line 6. Line 6 is a gas line transporting gases to the partial condenser. Liquids do not pass to the line 6.

The partial condenser 5 is arranged and/or configured to remove heavy fractions (lower higher point fractions) from the exiting gas, prior to the exiting gas being further passed to full distillation or condenser sections of the apparatus and process. In the partial condenser 5 the gas is cooled as discussed below. As the gas is cooled, heavier fractions condense and can be collected, while lighter fractions remain gaseous and are passed via line to the reboiler 16.

The partial condenser 5 is preferably provided with a packed column 28 with (optional) random packing material such as rings e.g. Raschig rings, which increases the contact surface area between the gas and the liquid which is condensed in the partial condenser. As is known in condensation processes, this may assist in effective condensation by providing a large solid surface area for condensing gases.

The partial condenser 5 is also preferably provided with a temperature-controlled cooling element 29, such as a cooling coil supplied with temperature regulated cooling medium. The temperature of the cooling element 29 is controlled to cause condensation of long-chain hydrocarbons (longer than C22, for example), which condensed materials fall under gravity to the lower part of the partial condenser 5. The cooling element 29 is preferably downstream of the packed column 28.

As alternatives, or additionally, selective condensation may be achieved by a cooling jacket (not shown) acting as a cooling element, or the partial condenser may be an external (full reflux) condenser.

The gases that do not condense (C1-C20/C22, possibly up to C35) in the packed column 28 or in the cooling element 29 discharge via a partial condenser upper outlet and pass via line 30 to a downstream distillation unit of a type commonly known for distillation use in the petrochemical arts, for example as used in distillation of crude or mineral oil fractions.

The downstream distillation section can be designed according to industrial standards as known to those skilled in the art. The gases can be fractionated into gaseous fractions and liquid fractions. A liquid fraction may be stripped off as middle distillate, and a gaseous fraction may be stripped off as light boilers in a distillation unit. Hydrocarbon products from the distillation unit may comprise butane, propane, kerosene, diesel, fuel oil; light distillates, such as LPG, gasoline, naphtha, or mixtures thereof; middle distillates such as kerosene, jet fuel, diesel, or mixtures thereof; heavy distillates and residuum such as fuel oil, lubricating oils, paraffin, wax, asphalt, or mixtures thereof; or any mixtures thereof. Hydrocarbon products may be saturated, unsaturated, straight, cyclic or aromatic. Further products may include non-condensable gases, comprising methane, ethane, ethene and/or other small molecules. The products may be a source of feedstock for steam crackers of the manufacture of plastics.

The hydrocarbons that condense in the partial condenser 5 (for example comprising ≥C22 chains, possibly including minor portions of <C22 carbon chains) collect as a liquid 31 at the bottom of the partial condenser 5.

The liquid level at the bottom of the partial condenser is controlled by one or more level control sensors and may be discharged batchwise or continuously. The level control in the partial condenser 5 can be achieved continuously by way of a flow control valve.

The condensed liquid 31 in the partial condenser is preferably discharged via a partial condenser lower outlet 32 and is passed to a reboiler 16 via line 33 controlled by optional valve 34. Valve 34 can be any of an open close valve or a control valve.

The condensed liquid 31 collects in the reboiler 16, where it is reheated by a heater 13, preferably an internal heating element or an internal heat exchanger. The reboiler heater 13 can be heated electrically, with thermal oil or other types of heating medium. The condensed liquid in the reboiler 16 is heated to a temperature higher than the temperature of the partial condenser. An external heating element or external heat exchanger may also be envisaged.

Light hydrocarbon fractions which may unavoidably be carried along with the partial condenser condensate liquid can in this manner be evaporated or boiled off and sent to the distillation apparatus via a reheater vessel upper outlet 15. These can then be included in the distilled products. This may improve product yields as compared to a system or process in which partially condensed material is directly returned to a pyrolysis zone. This may also be considered preferable to returning light hydrocarbons to a pyrolysis zone, where they may further crack or form a relatively useless heat drain as they are circularly heated to re-evaporate and thereafter recondensed.

The reboiler 16 is preferably comprised as a component of a distillation section and joined in fluid communication for gases via reheater vessel upper outlet 15.

Liquid 35 that is collected in the reboiler, and which does not evaporate through reheater vessel upper outlet 15 for distillation, may be pumped back into the separator vessel 12 via line 9 using pump 10, with optional further heating prior to entry into the separator vessel 12. The liquid may in this manner be further pyrolyzed to useful lighter products than those that condense in the partial condenser 5. For example, the liquid is returned to the separating vessel 12 and or pyrolysis zone and cracked until they are reduced to chain lengths of C20 to C22 or less. The product yield may thus be improved, and or the ratio of light to heavy products be more specified to customer requirements.

Alternatively, the liquid collected in the reboiler, and which does not evaporate through reheater vessel upper outlet 15 for distillation, may be collected as a useful product, for example the product may be paraffin, and be transported to a collecting vessel via valve 21.

The partial condenser coil 29 is typically operated at temperatures between 220 °C and 380 °C and the reboiler is typically operated at temperatures between 340 °C and 400 °C. These temperatures are both lower than the typical crack reactor operating temperature of 390 °C and 450 °C.

The liquid pyrolyzed material present in the separator vessel 12 is continuously circulated, preferably by means of an external pump 27. As the liquid is circulated it may be reheated to a pyrolysis temperature for further cracking by a heat exchanger 28.

A distillation column (not shown) is preferably provided atop reheater vessel upper outlet 15. The distillation column may be provided with a region designed as a packed column, and optionally within this region containing packing or preferably above this region, an intermediate tray on which the liquid fraction (diesel product or HHC) is collected and 5 may be discharged. The HHC, for example diesel, product discharged from the distillation unit is preferably cooled by means of a heat exchanger, and a portion of this cooled diesel product may be recirculated to the distillation unit via a recycle streamline in order to set optimal temperature conditions.

Possible settings leading to low range product compositions may include:
a partial condenser outlet temperature of about 290 °C;
a reboiler (liquid) temperature of about 360 °C,
an upper distillation column outlet temperature of about 80 °C,
an LHC condenser temperature of the condensed LHC liquid of about 42 °C about
Final Boiling Point of HHC: 430 °C

Possible settings leading to medium range product compositions may include:
a partial condenser outlet temperature of about 320 °C;
a reboiler (liquid) temperature of about 380 °C,
an upper distillation column outlet temperature of about 100 °C,
an LHC condenser temperature of the condensed LHC liquid of about 42 °C about
Final Boiling Point of HHC: 450 °C

Possible settings leading to high range product compositions may include:
a partial condenser outlet temperature of about 330 °C;
a reboiler (liquid) temperature of about 380 °C,
an upper distillation column outlet temperature of about 120 °C,
an LHC condenser temperature of the condensed LHC liquid of about 55 °C about
Final Boiling Point of HHC: 550 °C

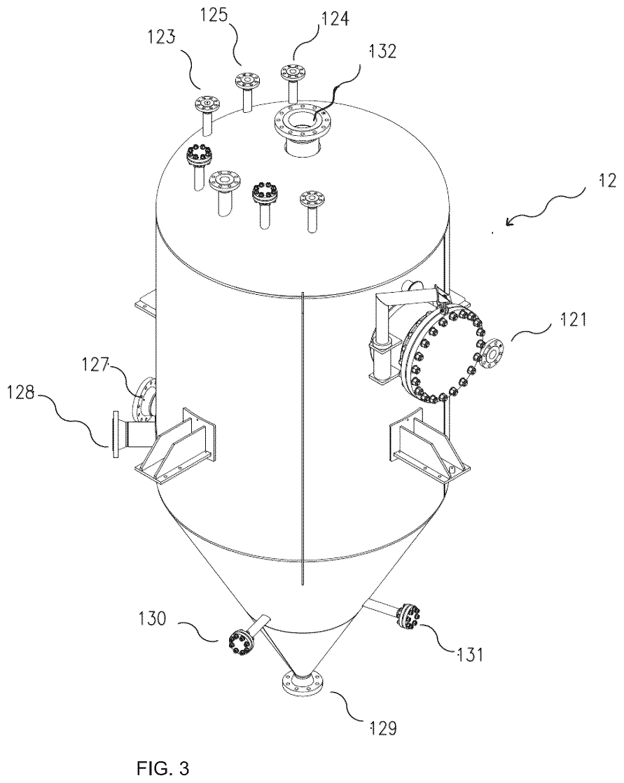

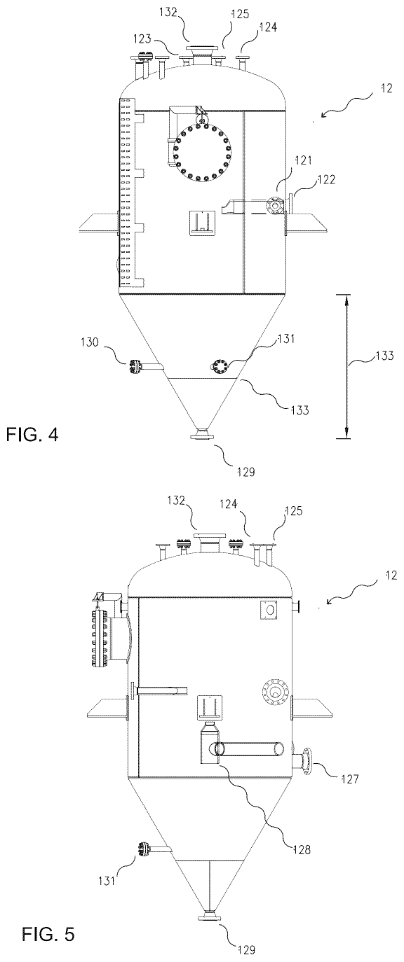

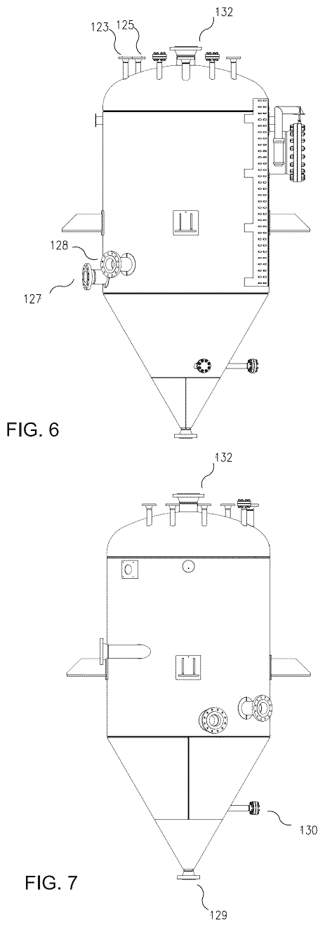

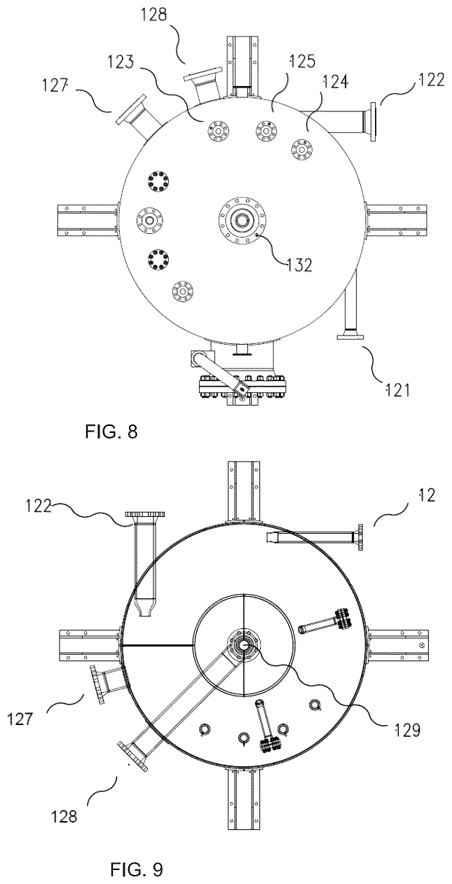

Referring to FIGS. 3 to 9, there is provided a more detailed illustration of the separation vessel 12 useable in the systems of FIGS. 1 and 2.

The separation vessel 12 in the plastic to chemicals (PTC) installation typically has multiple functions. Such functions may include any one, more or all of the following functions.

The separation vessel may function to aid in separation of the gas, liquid and solid particle phases present in an incoming stream of partially cracked plastics material. As discussed, the plastics material entering the separation vessel from the heating device 11 is at a temperature that it is undergoing pyrolysis yet is not yet fully pyrolyzed. The plastics material exiting the heating device 11 and entering the separation vessel 12 via inlet 14 thus comprises at least gaseous and (partially cracked) liquid components, which are to be separated for distinct further processes. The entering flow of material may also include solid, particulate material. A substantial portion of the solid particulates will result from the pyrolysis reaction and its generation of char or coke particles as is common to pyrolysis. Other particulates may be present due to impurities in the initial plastic feed stream to the process, such as metal particles, and other detritus.

In the separation vessel, gaseous material will separate from the liquid and solid materials due to gravity and pass upwardly toward exit points. The liquid and solid phases will pass downwardly and collect in the separator vessel 12.

In accordance with an aspect of the invention, efficiency and quality of the separation may be achieved through implementation of various velocity patterns for the fluid streams in the separator 12.

The separation vessel 12 may function to provide residence time for cracking of plastics materials in a pyrolysis zone; that is, in a zone at which the temperature is high to bring about pyrolysis. Plastics materials can remain for some time within the separator 12 and so be cracked, the liquid plastics materials may also be removed, reheated and returned to the separator vessel 12 for separation and/or further pyrolysis.

The separation vessel 12 may function to mix fresh incoming liquid plastics materials from the heater 11 and recycled partially cracked plastic materials from, for example, a heater external to the separation vessel 12, and/or a reboiler.

The separation vessel 12 may function to control the characteristics and quality of product streams through control of temperature, residence time, contained volume, and/or pressure.

The separation vessel 12 may function to separate solid particulates (e.g. coke, char particles, or other detritus) from a bulk of pyrolyzing liquid. This may be achieved by one or both of an advantageous separator vessel 12 shape, or flow patterns of the streams of material within the separator vessel 12. The solid particles may be removed as a bitumen. Advantageously the separator 12 may function to allow removal of solid particles, coke, char, bitumen, detritus, as part of a continuous pyrolysis process. That is, bitumen comprising solid particles, coke, char, detritus, may be removable from the separator vessel while pyrolysis continues within separator vessel 12.

The separation vessel 12 may function as a container to (temporarily) hold liquid (partially) cracked liquid plastics material, and thus maintain a volume of liquid (partially) cracked liquid plastics material in the system. This may advantageously ease (re)start-up operations, for example because system pumps can be primed at start-up from that volume of liquid, and/or provide a NPSH (net positive suction head) for pumps working on liquid within the separator vessel 12.

Referring to FIGS. 3 to 9, the separation vessel is shown in detail.

The illustrated separator vessel 12 is provided with a number of injection points and discharge points.

A fresh feed injection point 121 is provided at the sidewall of the separator 12, for receiving a fresh feed of plastics material exiting the heating device 11 and entering the separation vessel 12 through the inlet 14 in the fresh feed injection point 121.

A return feed injection point 122 is provided at the sidewall of the separator, through which return of reheated partially cracked plastics material may be returned following reheating in a recycling reheating loop 26.

A reboiler return injection point 124 is provided, preferably at the top of the separator vessel 12, for injection of liquid 35 (for example paraffins) that is collected in the reboiler 16 and pumped back to the separator vessel 12 via line 9. The liquid 35 collected in the reboiler 16 is preferably comprised of paraffin and/or long chain hydrocarbons having a boiling point of greater than about 400 °C.

The reboiler return injection point 124 is preferably positioned above the liquid level in the separator vessel 12, and most preferably at the top of the separator vessel 12. This may assist in preventing the reboiler return injection point 124 becoming fouled with carbon/char, as may be the case if the reboiler return injection point 124 is below the liquid level in the separation vessel 12.

Injection of the reboiler liquid 35 to the separator vessel 12 via line 9 is preferably injected semi-continuously, most preferably continuously. This is believed to advantageously provide a stable process for pyrolysis in the separator vessel 12, with predictable and stable heat distribution and/or predictable and stable flow streams within the separator vessel 12. This is believed to be advantageous as compared to batch delivery.

The liquid 35 returned from the reboiler 16 to the separation vessel 12 may be further cracked in the separation vessel 12 to provide more desired shorter-chain products.

A nitrogen injection point 125 is provided for injection of a nitrogen blanket over the pyrolysis reaction. The nitrogen injection point 125 is preferably positioned at the top of the separator vessel 12. Via a nitrogen injection point nozzle, a preferably (semi-) continuous flow of nitrogen gas is supplied to the upper zone of the separator vessel 12. Flow rates may be in the region of from 1-20 litres per hour, more preferably from 2 to 10 litres per hour. Provision of nitrogen gas may assist maintaining the pyrolysis system, the separator vessel 12, at atm pressure or preferably above. An overpressure (higher than ambient pressure) may assist in excluding oxygen incursion and hence reduce the risk of unwanted intrusion of air, which may negatively influence product quality, in particular of HHC product.

An internal, preferably substantially central liquid-outlet 128 is provided within the separator vessel's hollow body, through which liquid partially cracked plastics material may be removed (e.g. under the influence of a pump) and passed to the reheating loop 26.

A side liquid-outlet 127 is provided through which partially cracked plastics material liquid may be removed (e.g. under the influence of a pump) from substantially a peripheral region of the separator vessel and passed to the reheating loop 26.

A carbon outlet 124 is provided at the base of the separator 12, for discharge of bitumen containing carbon or other solids that settle to the bottom of the separator 12.

A pressure equalizer line 123 is provided. The pressure equalizer line can assist in pressure equalization during bitumen/carbon discharge from the base of the separator vessel 12.

Bitumen recirculation nozzles 130, 131 may also be provided. Bitumen, or high solidity content material at the base of the separator vessel 12 may be recirculated to reduce or prevent gelling, coalescence, coagulation or similar in the dense material. This may assist in preventing blockage of the carbon outlet 129.

A gas outlet 132 is provided at the top of the illustrated separator vessel 12, through (partially) cracked gaseous material formed during the pyrolysis reaction may be passed via line 6 to the partial condenser 5, and then on to the further processing in the form of optionally distillation, use as fuel, and/or further processing.

It is generally advantageous for all inlets and outlets to the separation vessel 12, where possible, to be flush on the inner surface of the separator vessel 12, that is, substantially non-protruding into the vessel. This may assist in reducing or preventing fouling and/or disturbance of flow patterns within the separation vessel.

In use for pyrolysis, a stream of fresh feed is passed into the separation vessel 12 from the heating device 11 via separation vessel inlet 14 at fresh feed injection point 121. The incoming fresh feed comprises gaseous and liquid phases resulting from melting and cracking that has taken place in the heating device 11. Upon entry to the separation vessel 12, the incoming cracked gases and liquid separate. Gases rise to the gas outlet 132 and exit to a partial condenser 5 via line 6, and liquids (with any entrained solid particles) accumulate in the separation vessel 12, with the solid particles sinking through the liquid phase to the bottom part. The separator vessel 12 is filled to a predetermined level with the liquid phase at its lower part, with the gaseous phase separating upwardly to an upper portion of the vessel in which predominantly a gaseous phase is present.

In the illustrated embodiment, the fresh feed of gas/liquid mixture is shown to be injected tangentially into the separator vessel 12. The gaseous phase and liquid phases then separate upwardly and downwardly respectively in the inner volume of the separation vessel 12.

Tangential introduction or injection of the fresh feed may, at least partially, provide a swirling or cyclonic flow pattern to the incoming gas/liquid stream. This may assist in efficient phase separation of the stream with the denser liquid being centrifugally driven to the periphery and the gas rising upwardly.

The liquid, and entrained solids, collects at the bottom portion of the separator vessel 12. The liquid that collects is not yet adequately cracked for all product characteristics that may be desired and is still too heavy for distillation. In the plastic to chemicals conversion process, the liquid is thus subjected to further residence time under pyrolysis conditions to further crack the polymer chains.

As discussed previously herein, it has been found to be useful to avoid provision of heating means on or in the separation vessel 12, as may be found in some prior attempts, for example, heating of wall of a crack reactor, or provision of a heating element or heat exchanger internal to a crack reactor.

To introduce heat into the separator vessel 12 and so maintain a pyrolysis temperature therein, liquid collected in the lower portion of the separator vessel 12 is removed from the separator vessel 12, and passed through a recycling, heating loop 26, where the liquid, partially-pyrolyzed plastic material is reheated to pyrolysis temperatures by the heat exchanger 28, and then returned to the separation vessel 12. In some embodiments the reheated plastics material may be combined with the fresh feed prior to injection into the separation vessel 12. In the embodiment illustrated in FIGS. 3-10, the recycled stream a return feed injection point 122, which is separate to the fresh feed injection point 121, is provided at the sidewall of the separator vessel 12, through which return of reheated partially cracked plastics material is returned following reheating in a recycling reheating loop 26. The return feed stream carries heat into the separation vessel 12, maintaining pyrolysis conditions within the separation vessel 12, and simultaneously provides additional residence time for plastics materials that are still to be further cracked until the resultant shorter chain hydrocarbons can be processed through to distillation and desired product.

The liquid level in the separator vessel 12 may be controlled, for example, by balance of the fresh feed input and the output of gaseous cracked material. The rate of output of gaseous material is predominantly controllable via the rate of pyrolysis, that is, by control of the temperature in the separator vessel 12. That temperate may be controlled by way of the rate of circulation of the liquid via the recycling, reheating loop 26, and/or the temperature of the heater in the recycling, reheating loop 26.

The equilibrium liquid level may also be controlled by control of the rate of fresh feed input, by increasing or reducing the feed of fresh molten plastics from the heater 11. The equilibrium liquid level may also be controlled by control of the rate of removal of char or purge of char from the separator vessel 12. by increasing or reducing the removal of char containing material from the base of the separator vessel 12.

The pressure of the separator vessel 12 is preferably maintained above atmospheric, preferably slightly above atm pressure, such as for example in the range of 50 to 100 mbarg. Pressure in the separator vessel 12 may be controlled to influence product yield, and it is envisioned that the separation vessel 12 may be operated at higher pressures or at pressures below atmospheric pressure.

Operation of the separation vessel at higher pressures, for example at 100 mbarg or higher, preferably 200 mbarg or higher, more preferably 300 mbarg or higher, may assist in production of lighter products with lower final boiling points, or of a greater fraction of lighter products. Still higher pressures of above 5 barg or above may employed. Without wishing to be bound by theory, it is believed that higher pressures suppress evaporation of hydrocarbon chains, and that long chain hydrocarbons suffer more from this effect than small chain hydrocarbons. The hydrocarbons, particularly the longer chain hydrocarbons, will less readily evaporate remaining in the pyrolyzing zone and being cracked further into lower boiling hydrocarbons.

Operation of the separation vessel at lower pressures, for example at less than atmospheric, e.g. less than Ombarg, preferably less than 10 mbarg, more preferably less than 30 mbarg, more preferably less than 50 mbarg, may assist in increasing the fraction of with high boiling points, such as paraffins. Still lower pressures of above 0 bar abs (a vacuum reactor) may be employed. Without wishing to be bound by theory, it is believed that at lower pressures, the long chain hydrocarbons will more readily vaporize, exiting the pyrolyzing zone prior to their being cracked further into lower boiling substances.

The temperature and residence time inside the separator vessel 12 are interrelated. By balancing these two parameters, preferred liquid volumes in the separator vessel 12 may be achieved. For example, higher temperatures may result in faster cracking and gasifying rate, reducing the residence time of material in the system.

The temperature of the liquid in the separator vessel 12 is controlled to be a pyrolysis temperature. Preferably the temperature of the liquid body in the separator vessel is controlled to be about 360 °C or greater, more preferably about 390 °C or greater, preferably 395 °C or greater, preferably 400 °C or greater, more preferably 410 °C or greater. A pyrolysis temperature may be in the range of 360-550 °C more preferably 390-450 °C, more preferably from about 400 °C to about 450 °C. Higher temperatures increase the rate of the cracking reaction.

Residence time in the pyrolysis zones of the apparatus and operation is preferably from about 10 minutes to about 12 hours, more preferably from about 20 minutes to about 6 hours, more preferably from about 30 minutes to about 3 hours. The residence time is a measure of the time for which a volume of material is present in pyrolysis zone. Residence time for the system may be calculated as volume (m3)/flow (m3/s). The residence time may be reported as mean residence time or mean transit time, that is the mean residence time of all material leaving the control volume at time t.

Temperatures and rates of production may vary in a pyrolysis process, being adjustable to variety in feedstock plastic. This may allow the process to be adaptable to different plastic types, in particular plastic types of varying cracking temperatures. The operation may be adjusted to crack homogeneous feedstock or heterogeneous feedstocks with two or more plastic types.

As discussed, the separator vessel 12 is provided with a fresh feed injection point 121 and a return feed injection point 122. It has been found that the fresh feed injection point 121 and the return feed injection point may have a substantial influence on the flow behaviour of the fluids inside the separation vessel 12.

One, or preferably both, of the fresh feed injection point 121 or return feed injection point 122, may be arranged to inject gas/liquid feed substantially tangentially into the separator vessel 12, preferably along or over the inner wall of the separation vessel 12, preferably in a circumferential direction. The injection points 121, 122 preferably inject the feed into the separation vessel below the level of the liquid in the separation vessel 12, setting up a rotational, swirling or cyclonic flow pattern in the liquid. One or more of the injection points 121, 122 may alternatively be positioned to inject the feed into the separation vessel above the level of the liquid in the separation vessel 12, although this is less preferred.

A cyclonic effect may be obtained by the discussed introduction in a gas/liquid zone below the collected liquid. Advantageously this is without the need for an auger or similar stirring device to drive the body of collected liquid into a cyclonic rotation.

This cyclone effect may advantageously improve one or more of sedimentation of solids, in particular dense particles (denser than the liquid), inside the separation vessel 12; distribution of the heat of the incoming feeds to material already in the separation vessel 12; separation of gas and liquid; provide a central zone in the body of collected liquid that has a relatively low concentration of solid particles, such as carbon particles, from which liquid can be taken by the internal, preferably substantially central liquid-outlet 128 and be passed to the reheating loop 26. This may assist in reducing or preventing build-up of blockages within the reheating loop 26, the pump 27, the heat exchanger 28, and/or the return feed injection point 122.

The strength of the swirling, cyclone effect may be controlled by control or variation of the inlet velocity at the fresh feed injection point 121 and/or return feed injection point 122 (e.g. by variation of pump capacity, higher recirculation flow, or greater mass injection), as well as by the ratio or relative inflow rates of the two inlet velocities.

Inlet velocity may be increased by a narrowing of the inlet nozzle at the point of injection, for example the fresh feed inlet nozzle may reduce from an internal pipe diameter of about 8 cm to about 6 cm and the return feed inlet nozzle may reduce from an internal pipe diameter of about 15 cm to about 8 cm. The narrowing of the nozzles is illustrated in FIG. 9.

Velocity at the fresh feed injection point 121 and/or return feed injection point 122, may also increase due to the generation of pyrolysis gases in the heater 11 and reheating loop 26, which both include pyrolysis temperature zones. As the gas expands into the relatively lower pressure separation vessel 12, the gas can accelerate to a high inlet velocity, assisting in creation of cyclone effects.

The cyclonic flow effect may also be controlled through the ratios of flow rate and/or velocity between fresh feed injection point 121 and the return feed injection point 122. Preferably the ratio of the flow rate (litres per second) between the fresh feed injection point 121 and the return feed injection point 122 is preferably from about 1:1 to 1:25, more preferably 1:20, more preferably 1:15, most preferably 1:8. An operating ratio may be selected (for example preferably from about 1:1 to 1:25, more preferably 1:20, more preferably 1:15, most preferably 1:8), and be adjusted during operation by e.g. lowering the frequency control of an associated pump. The ratio of the feeds may be adjusted during operation to slow or accelerate pyrolysis, raise or lower the temperature in the separator vessel 12.

Additional or alternative injection nozzles may be provided at various circumferential positions as may be optimized to achieve a stable cyclonic effect.

The cyclonic flow effect may also be controlled through adjusting the surface roughness of the inner walls of the separator vessel 12. Lower surface roughness decreases the friction between the walls and the liquid, thereby influencing the velocity of the liquid inside the vessel.

While prior attempts have been made to inject hot plastic melt in pyrolysis operations, the present invention may advantageously achieve improved separation, heat distribution and/or reheating of liquid pyrolysis materials, by way of the injected gas/liquid mixtures at elevated velocities and/or at defined substantially tangential angles, and different ratios between injection nozzles, into a reactor vessel, which causes the liquid to swirl.

Other prior attempts to inject hot plastic melt in pyrolysis operations has involved premixing of the fresh feed and return feed, prior to entry into a pyrolysis vessel. Without being bound by theory, the present invention is advantageous because the fresh feed may be more efficiently introduced to the separation vessel.

It has been determined that a heater 11 that results in pyrolysis prior to the separation vessel 12, for example achieving pyrolysis temperatures prior to injection into the separation vessel, may generate a large portion of gaseous material. It is believed that a more efficient process may result by release of that gaseous material into the separator vessel 12 prior to mixing with a return feed. It is believed that this may assist reducing or preventing further or excessive cracking of those already gaseous materials.

Furthermore, without wishing to be bound by theory, it is believed that injection of the fresh feed into the separation vessel 12 separately from the recycled, reheated stream, may improve efficiency and resilience of the system, in particular of pumps in the recycle line 26. This may be because pressure peaks or pressure pulses that may occur in the fresh stream feed due to high gas content in the fresh feed and high pressures, will be less transmitted to pumps in the recycle stream 26. Instead, the relatively large volume of the separator vessel 12 is able to absorb or dissipate pressure peaks associated with the fresh feed injection. This may assist in improving the efficiency and reducing maintenance needs for pumps in the recycle loop 26.

As a result of pyrolysis (thermal decomposition of materials at elevated temperatures in an inert atmosphere) cracking the hydrocarbons, there will be formation of coke (char) particles in the plastic material streams. The coke particles form in all pyrolysis zones of the process, including the heater 11, the separation vessel 12, and the recycling, heater loop 26. The solid coke particles will tend to accumulate at the bottom of the separator vessel 12.

In addition to the solid coke particles, other particulates may be present due to impurities in the initial plastic feed stream to the process, such as metal particles, and other detritus. The feedstock may comprise inorganic materials, for example sand, glass, metal, or similar, preferably less than 10 wt. % of inorganics, more preferably less than 5 wt. %.

It is advantageous to avoid or prevent excessive accumulation and resultant blockage of the separation vessel 12 and/or to efficiently remove the solid particles to avoid contamination of products.

As discussed in relation to the tangential introduction of the stream of fresh feed at fresh feed injection point 121, and the tangential introduction of the recycled, reheater stream at the return feed injection point 122, the injection affects flow behaviour inside the separator vessel 12. Tangential introduction through one, both or more of such nozzles can cause the fluids inside the crack reactor vessel to form as a cyclone. This cyclone effect may advantageously improve the sedimentation of solids inside the separation vessel 12, similarly to a centrifuge. This may advantageously provide that (centrifuged) solids remain adjacent to the inner wall, and sink being less sucked in by the pump than light fluid.

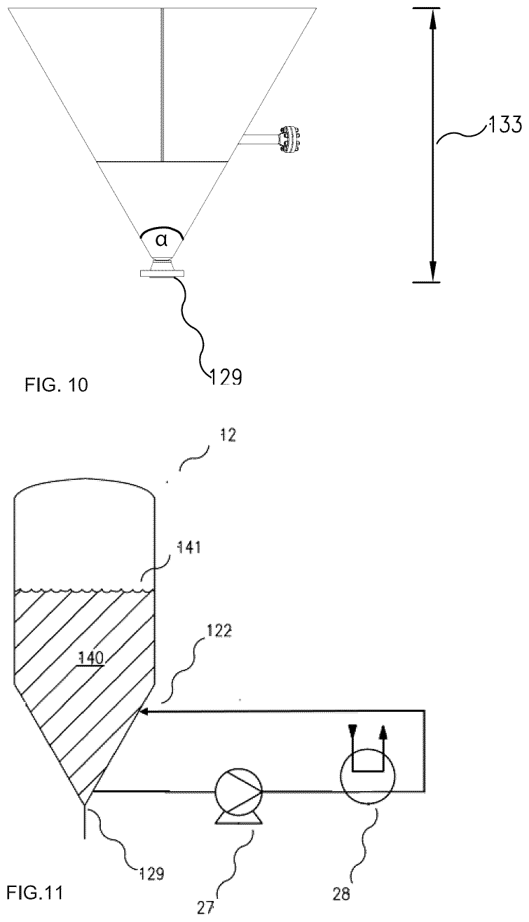

Referring to FIG. 10, a lower conical portion of the separator vessel 12 is illustrated, which culminates at its lowest point in the carbon discharge point 129.

Solid particles present in the pyrolyzing liquid in the separation vessel 12 will tend to drop to the bottom of the separation vessel 12, settling and accumulating in the illustrated lower conical portion 133, where the fluid streams are less energetic or are relatively still with a low velocity.

As the solids reach the bottom of the separator vessel 12, the solids accumulate. The conical form of the reactor bottom assists in leading the settling solids towards the carbon discharge section.

The settling of the solid particles by the lower conical portion is particularly effective in combination with the cyclonic effect, which drives the solids toward the inner wall of the separation vessel 12.

Without being bound by theory, it is believed that the angle of incline of the cone is of importance to achieving effective settling of the solids and avoiding blockages in the lower part of the separator vessel 12. Through investigation it was found that the angle of incline of the conical reactor's inner surface should be balanced between being adequate so that the particular type of solid particles arising in pyrolysis will not adhere or build up on the separation vessel's 12 inner walls, yet still allow the solids to pass to the carbon outlet 129. Steeper angles may also lead to excessive vessel height and may result is a limited volume in the lower part thereof.

Without being bound by theory, it is believed that efficient pyrolysis may be achieved when a separator vessel 12 is provided with a conical lower part 133 with an internal opening angle a of the conical lower part of the separation vessel 12 that is between about 30° and about 70°, more preferably between about 50° and about 70°, more preferably between about 55° and about 65°, and most preferably of about 60°.

Furthermore, without being bound by theory, it is believed that separation of solid particles may be improved by limiting the surface roughness of the inner surface(s) of the separation vessel 12, in particular of the conical lower part 133 thereof. This can assist in ensuring effective, rapid settling, as well as helping to reduce build-up of blockages and prevent fouling and build-up of carbon solids.

Efficient pyrolysis may be achieved when a separator vessel 12 is provided with inner surface surface-roughness of Ra 20 or less, preferably Ra 18 or less, more preferably Ra 15 or less, more preferably Ra 12 or less, most preferably Ra 6 or less, for one or more of its inner surfaces. Preferably the inner surface of the conical lower pat has such a limited surface roughness.

Surface roughness is measured as the roughness average (Ra), which has the unit of micrometers. Methods for measuring the surface roughness are known to the skilled worker. As an example, surface roughness may be measured using a perthometer with a diamond probe that registers uneven hights of a surface. Methods to adjust the surface roughness of a given material are also known to the skilled worker and may include, but are not limited to, snagging, sawing, planing, shaping, drilling or (chemical) milling.

In previous proprietary attempts at implementation of plastic to chemical plants, a vessel assisting in separation of pyrolyzing liquid and gas was not equipped with a conical bottom but with an ellipsoidal head. This alternative caused the bottom to fill with contaminants and ultimately caused the reactor to fill and clog.

In a further previous proprietary attempt at implementation of plastic to chemical plants, a vessel assisting in separation of pyrolyzing liquid was equipped with an inverted cone in the bottom of the vessel. The purpose of the reversed cone was to stop flow in the bottom of that vessel resulting in recirculation, and improve sedimentation of solid particles. However, it was determined via research that clogging occurred due to the inverted cone. For example, the peripheral opening about the inverted cone could be blocked with char and char could build up on the inverted cone.

Previous technologies have been unable to achieve (semi)-continuous discharge of solid particles such as carbon, or on-the-go discharge of particles such as carbon. In prior attempts at pyrolysis, shutdown of pyrolysis has been required for a given pyrolysis zone while (dry)carbon, char, is removed by attrition. The conical shape of the lower part 133 and the cyclonic fluid flows in the separator vessel 12 of the present invention may assist in achieving efficient carbon removal, without, or with reduced, shut down requirements for pyrolysis. In particular, the combination of the conical shape of the lower part 133 and the cyclonic fluid flows is effective. Continuous char removal may be advantageous.

Referring to FIG. 11, a schematic illustration is shown of the separation vessel 12 provided with recycle, reheating loop 26. The recycle, reheating loop 26 is a source of heat energy to the separator vessel 12, preferably the main heat energy source to the separation vessel 12.

Liquid 140 in the lower part of the separation vessel 12, e.g. comprising molten plastic and partially pyrolyzed hydrocarbons is pumped with the aid of pump 27 to a heat exchanger 28, preferably a shell in tube heat exchanger. The heat exchanger 28 (re)heats the liquid to a temperature above that of the temperature of the liquid in the separation vessel 12. For example, from about 410 to about 550 °C, more preferably from about 410 to about 500 °C, still more preferably from about 410 to about 450 °C.

Since pyrolysis occurs at these temperatures, the pumped liquid stream will generate pyrolyzed gas and comprise a portion of gas. To reduce cavitation effects in the pump 27 it is preferred that the pump is upstream of the heat exchanger 28, so that the pump 27 is presented predominantly with liquid phase.

The (re)heated fluids pass back to the separator vessel 12, carrying heat energy with them, and heating the separator vessel 12 internally.

The fluids inside the heat exchanger 28 preferably have a minimum velocity to maintain solid particulates in suspension (prevent sedimentation), and to reduce fouling of heat exchanger surfaces with carbon or char. The minimum velocity is preferably about 1m/s, more preferably about 2m/s at the inlet of the heat exchanger 28. The velocity at the outlet of the heat exchanger 28 may be higher due to gas formation increasing volume and pressure.

The liquid, gas mixture is then led by the recycle, reheating loop 26 to be tangentially injected at high velocity (e.g. about 5m/s, more preferably about 8m/s, most preferably about 10m/s) into the crack reactor. The tangential injection may advantageously aid in providing a swirling or cyclone flow pattern in the fluids in the separation vessel 12. The liquid, gas mixture is injected below the liquid level 141. This may assist in generating desired flow patterns in the gas/liquid zone in the separator vessel 12 and/or in reducing or preventing blockage of the injection point.

The liquid 140 in the lower part of the separation vessel 12 is withdrawn from the separator vessel 12 via one or more outlets.

In the illustrated embodiment, two outlets are shown, an internal, preferably substantially central liquid-outlet 128, within the separator vessel's hollow body, and a side liquid-outlet 127. The liquid-outlets 128, 127 may be employed individually or jointly.

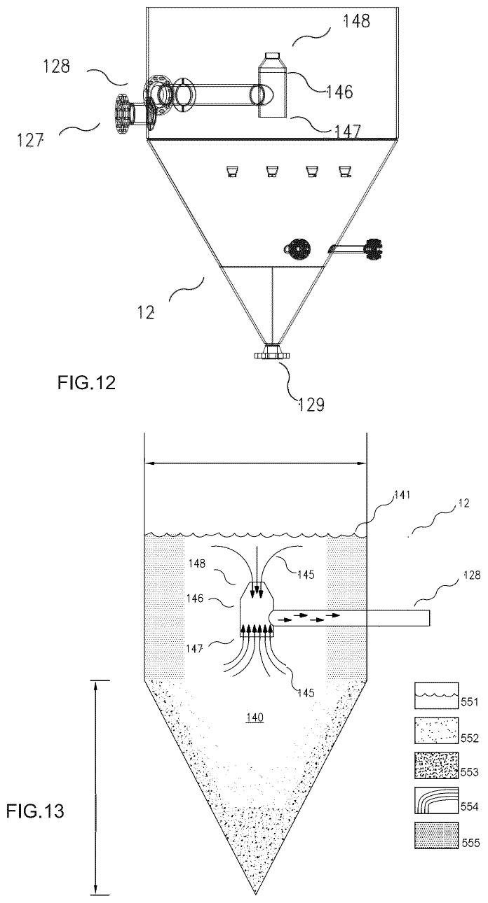

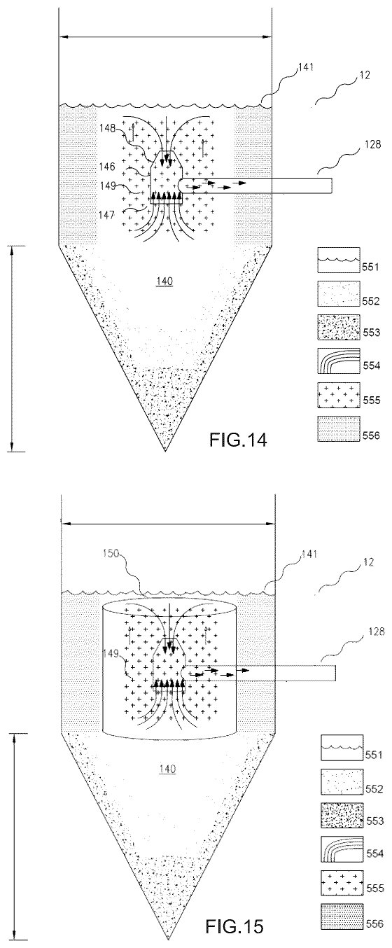

Referring to FIGS. 12 to 13, the internal liquid-outlet 128 is radially centrally situated in separator vessel 12, although non-central positioning or substantially radially central positioning may be employed. The internal liquid-outlet 128 opening is positioned below the liquid level 141 in the separator vessel 12 so that liquid can be withdrawn. A substantially central location of the internal liquid-outlet 128 opening may be advantageous because in the cyclonic fluid streams in the separator vessel 12, the radially central portion is relatively low velocity as compared to the radially outer fluid streams, and the solid particles will tend to have been centrifuged to the circumferential periphery. The liquid of relatively low solid particle content can so be withdrawn at the internal liquid-outlet 128 opening, as illustrated by arrows 145 in FIGS. 13 and 14.

In FIG. 13 and the provided key shows liquid level 551, liquid flow close to inner surface with lower tangential velocity 552, solid particles (carbon particles) in liquid 553, liquid flow directions 554, liquid passing to pump inlet 555, high velocity liquid sections 556 at radially outer portions of vessel 12, and gas bubbles 556. Some portion or only a low concentration of gas bubbles 556 may be present at this position.

The internal liquid-outlet 128 opening is preferably placed above the level of the conical bottom portion 133, or the settling zone, to reduce intake of settled solid particles in that conical bottom section 133.

The illustrated internal liquid-outlet 128 opening is provided with a vertically oriented outlet 146 comprising a lower opening 147 and an upper opening 148, with a sidewall extending between the openings. The lower part of the outlet 146 has the form of a cylinder (with circular, or any other, cross-section) and the upper part leading to the upper opening 148 has a frustoconical form. The outlet 146 may be formed to comprise a pipe oriented vertically with a reducer on top. The upper opening 148 is smaller than the lower opening 147.

The positioning of the outlet 146 may advantageously assist in minimizing the quantity of solid particles entrained with the liquid that is withdrawn via outlet 146, and carried into the reheater, recycling loop 26. This may assist in reducing blockage of the reheater, recycling loop 26, its pump 27 and its heater 28.

The larger portion of the liquid will flow into the outlet via the lower opening 147, with the lower opening 147 being larger than the upper opening 146, that is the upper opening 148 is reduced compared to the lower opening 147. The reduced sizing of the upper opening 148 may advantageously force liquid circulation to the top of the vessel. It may also assist in reducing entrainment of gas into the withdrawn liquid stream that is taken to the recycling loop 26.

Due to ongoing pyrolysis in the separator vessel 12, pyrolysis gas is generated in the liquid body, resulting in a two-phase mixture of bubbles 149 in liquid. It is undesirable that gas bubbles be entrained with the flow to the recycle, reheater loop 26 for a number of reasons. The gas may cause cavitation or other difficulties in the pump 27. The gas is already sufficiently cracked to exit the separation vessel 12 to partial condenser, and it is preferable that it not heated further and cracked to still shorter chains. The reduced size upper opening 148 at the top of the outlet 146 reduces intake to the outlet from above yet allows gas bubbles to pass through toward the top of the separation vessel 12, as illustrated in FIG. 14. Low flow rates to the outlet may also assist in reducing gas intake as the gas is able to rise sufficiently fast.

The ratio of the open area of the lower opening 147 to the open area of the upper opening 148 is preferably greater than 1, preferably greater than 1.5, more preferably greater than 2, more preferably greater than 4.

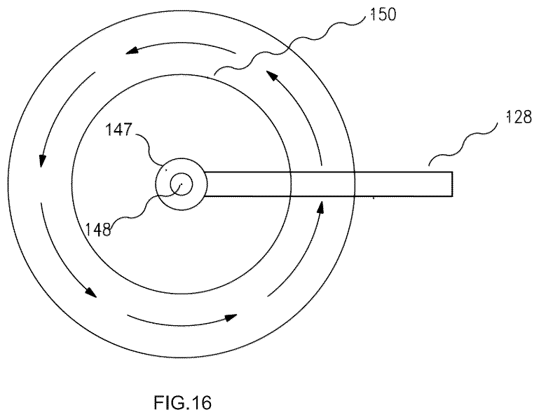

Referring to FIG. 15 a shroud 150 is illustrated positioned about the outlet 146 enclosing or delimiting a volume around the outlet 146 within the separation vessel 12.

The shroud 150, which is illustrated in a preferable form as a duct, preferably a cylindrical duct or pipe with open upper and lower ends, may advantageously assist in limiting entrainment of solid particles into the liquid withdrawn via outlet 146.

The shroud 150 is preferably substantially concentric with the outlet 146, which itself is preferably radially central in the separator vessel 12.

The shroud 150 internal to the separator vessel 12 is preferably at least partly submerged within the liquid body within the separator vessel 12. It preferably delimits a radially inner portion of the liquid volume that has a concentration of solid particles, which concentration of solid particles is lower than a concentration of solid particles in a radially outer volume of the liquid. This may be achieved because the solid particles in the separator vessel 12 will tend to be centrifuged to the circumferential periphery in the separator vessel 12. The solid particles will so tend to sink radially outwardly of the shroud 150, and the shroud 150 may assist in limiting or preventing radial incursion of solid particles towards the outlet 146. The liquid of relatively low solid particle concentration can so be withdrawn at the internal liquid-outlet 128 opening from a low kinetic energy zone (lower flow speeds than external to the shroud 150) within the shroud 150, as illustrated by arrows 145 in FIG. 15.

The shroud 150 internal to the separator vessel 12 is preferably fully submerged within the liquid body within the separator vessel 12. It is believed that liquid is then able to readily escape out of the top of the shroud 150 or from the bottom of the shroud 150, and that this may assist in avoiding dead or stagnant zones in the liquid.

A flow pattern of liquids around the shroud 150 is illustrated in FIG. 16. The circular flow will tend to centrifuge solid particles radially outwardly, while the fluid within the shroud 150 is protected from transfer or kinetic energy or solid particles.

The shroud 150 may partially or fully surround the liquid outlet point. It may have substantially solid walls or porous walls with filter holes.

Preferably the wall or walls of the shroud 150 are substantially vertical as this may assist in limiting or avoiding fouling by solid material. In general the walls are thin to minimize flow interruption and to minimize horizontal surfaces.

Preferably a wall or walls of the shroud 150 are smooth to minimize or avoid fouling. Preferably the surface roughness of a wall or walls is less than Ra 25 μm, preferably less than Ra 15 μm, more preferably less than Ra 12 μm, even more preferably less than Ra 10 μm, even more preferably 6 μm, even more preferably 4 μm.

Without wishing to be bound by theory, the shroud 150 may contribute to improving or maintaining separation of liquid and solids within the separation vessel 12, which may lead to reduced or prevention of clogging in components of the recycling, reheater loop 26. It may also assist in improving tolerance to high solid particle concentrations within the separator vessel 12, reducing the overall purge quantity from carbon discharge 129, which in turn may higher product yields.

Alternatively, or in addition to the internal liquid-outlet 128, a side-liquid outlet 127 substantially flush with the inner wall of the separator vessel 12. The side-liquid outlet 127 is positioned below the liquid level 141 in the separator vessel 12 so that liquid can be withdrawn and is preferably positioned above the level of the conical bottom portion 133, or the settling zone, to reduce intake of settled solid particles in that conical bottom section 133.

During operation it is possible to employ one or both an internal liquid-outlet 128 and a side liquid-outlet 127. The ratio of liquid withdrawal when both are employed may be from 100:0 to 0:1000, 90:10 to 10:90 or preferably from 60:40 to 40:60, preferably about 50:50.

The withdrawal of liquid via the side liquid outlet 129, and/or the ratio of withdrawal between the outlets, may advantageously influence the velocity and flow pattern within the separator vessel 12. In particular a flush construction of the side liquid outlet 129 with the vessel wall may assist in providing an uninterrupted flow pattern within the vessel.

The withdrawal of liquid via two or more liquid-outlets, either internal or side, may be advantageous due to reduced pressure drop in the pump 27.

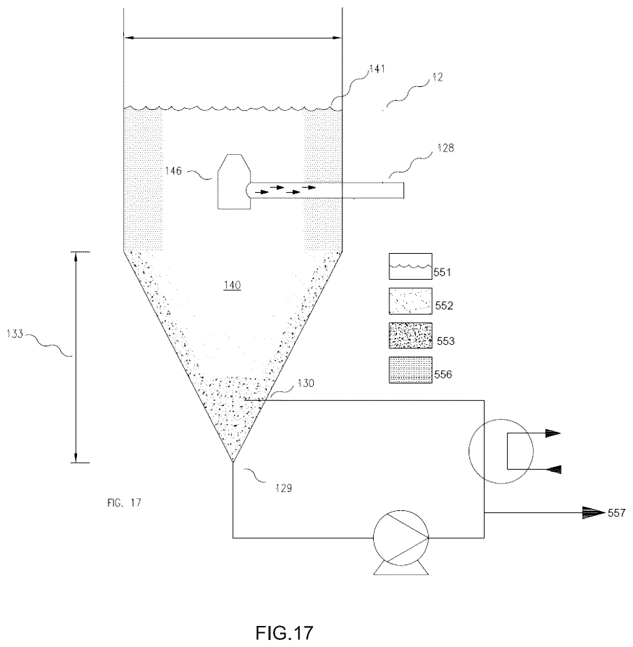

Referring to FIG. 17, as discussed, solid particles present in, or generated in, the pyrolyzing liquid in the separation vessel 12 will tend to drop to the bottom of the separation vessel 12, settling and accumulating in the illustrated lower conical portion 133, where the fluid streams are less energetic or are relatively still with a low velocity. Liquid comprising high concentrations of solid particles can be expelled via the carbon discharge point 129.

Through research it has been determined that failures may occur in expulsion of carbon particle rich liquid via a carbon discharge point 129. Provision of bitumen circulation nozzles 130, 131 may assist in providing a more effective particle-rich-liquid expulsion and hence provision of a more robust and low-maintenance apparatus and process. Bitumen, or high solidity content material at the base of the separator vessel 12 may be recirculated via the bitumen circulation nozzles 130, 131 to reduce or prevent gelling, coalescence, coagulation or similar in the dense material. This may assist in preventing blockage of the carbon outlet 129.

The high-solids content liquid may be removed via carbon discharge point 129 and recirculated via lines for re-entry via bitumen circulation nozzles 130, 131.

The high-solids content liquid may be reheated or cooled prior to being returned to the separator vessel 12. A heater or cooler may be provided to that end. The temperature in the separation vessel 12 may in this manner be at least partially controlled or affected.

The high-solids content liquid may be sampled or monitored by one or more sensors during recirculation, to determine the solid particle concentration. This may assist in accurately determining a volume of high-solids content liquid for disposal to avoid excessive build-up of solid particles in the separator vessel 12. This may assist in providing an efficient pyrolysis due to more limited loss of hydrocarbon product to purge streams and/or reduced maintenance operations such as cleaning or de-clogging.

A sample point 557 in the return lines may be provided. Sensors may include density sensors, turbidity sensors, viscosity sensors, flow sensors, spectrometers, radioactive sensors, ultrasound or similar.

Circulation of bitumen or high solidity content material at the base of the separator vessel 12 may also be advantageous in the event of (temporary) shut-down, slow-down, or start up procedures as a manner to maintain or provide heating and kinetic energy to the lower part of the separator vessel 12. This may reduce or prevent clogging at the base of the separation vessel 12 because the hydrocarbons remain liquid, and solids remain in suspension.

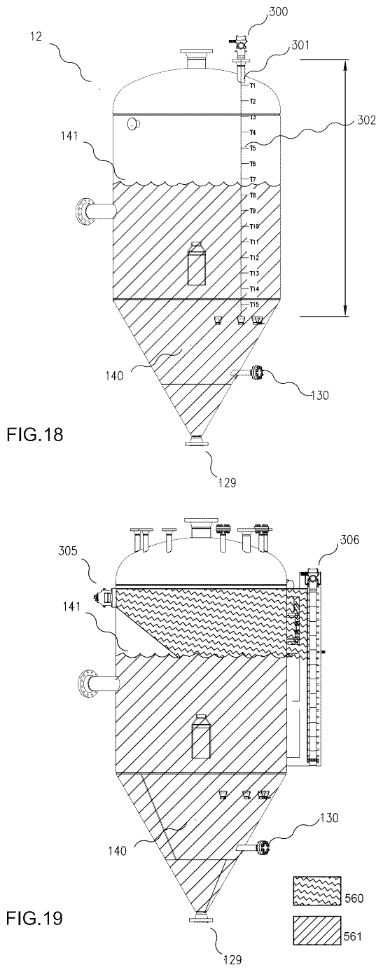

Referring to FIGS. 18-20, the liquid level inside the separator vessel 12 may be measured in a number of different ways. A number of alternatives are illustrated, although others may be contemplated. For accuracy, two or more, or all of the discussed alternatives may be implemented.

The liquid level inside the separation vessel 12 is complex to measure. Some sensors may fail due to fouling or degrade due to harsh conditions, other sensors may be inaccurate due to foaming at the liquid surface giving false readings.

A radar measurement device may be provided, preferably a guided wave radar measurement.

The guided wave radar measurement is placed inside the separation vessel 12. A guided wave radar level transmitter is placed on top of. The guided wave radar measurement may provide a broad operating range, with good reliability. In particular, a rod type guided wave radar is suited for operation with foaming liquids, and the measurement operates independently of noise, pressure, temperature and density variations. Furthermore, fouling on the guided wave radar probe or on the separation vessel's inner surfaces, have minimal influence on the measurement accuracy.

The guided wave radar measurement is used as the measurement device for the level control in the reactor vessel.

In FIG. 18 a temperature measurement level sensor arrangement is illustrated, preferably a multipoint temperature measurement sensor arrangement.

The multipoint temperature measurement is placed inside the crack reactor. A multipoint temperature communicator 300 is preferably placed in nozzle 301. The temperature rod 302 is mounted at the top of the vessel. The temperature measurement rod 302 is equipped with a series of separate temperature sensors, for example from two or more, five or more, or about twelve or more, spaced along the length of the rod 302. The level of the liquid can be assessed based on a difference in temperature between adjacent sensors on the rod 302. It has been determined through research and practice that the liquid phase is typically if not always hotter than the gas phase by a number of degrees, for example a difference of from 3°C to 6 °C between the gas and liquid phase.

The accuracy of the temperature measurement will depend upon the number of temperature sensors provided on the rod 302 and the spacing thereof.

A further advantage of the temperature-based measurement of the liquid level is that information as to the overall pyrolysis process in the separator vessel 12 may be simultaneously derived, especially during start up or transient situations. During start up for example, the bottom of the vessel may remain cooler than liquid higher in the vessel. This may be caused by the greater density of the cold liquid. The multiple temperature feedback from the rod 302 may alert an operator to sub-prime conditions in the separation vessel 12.

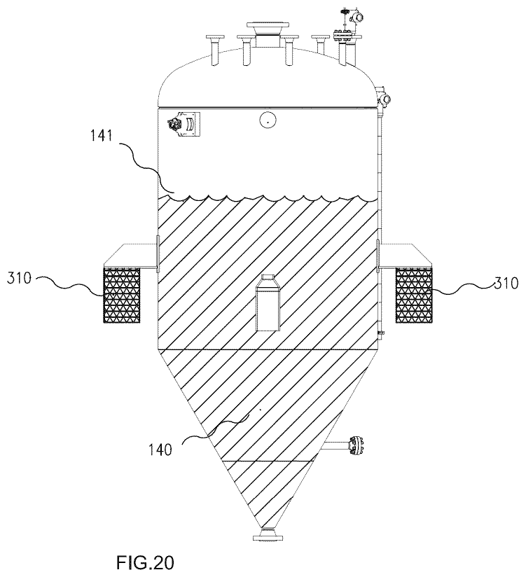

In FIG. 19 an external radiation measurement device is illustrated, preferably an external Gamma source level measurement device. The key in FIG. 19 shows radiation 560, and liquid level 561.

The illustrated separation vessel 12 is equipped with an external radioactive level measurement device comprising a radiation source 305 (preferably gamma or X-ray radiation) and a radiation detector 306. It has been found that radioactive level measurement provides accurate liquid level measurement despite dynamic processes and conditions in the pyrolysis zone, including foaming and potential fouling. In particular, radioactive level measurement does not require internal probes or other internal sensors.

In FIG. 20 mass-based measurement is illustrated. The mass of liquid, and hence also the liquid level can be determined based on a determined mass. Load cells 310 are arranged to measure weight of the separator vessel 12. To load cells 310 are arranged at the supports of the reactor vessel.

As an alternative or complementary measurement, the separator vessel may be provided with differential pressure measurement. Based on differential pressure measurement and a density of the liquid, the liquid level may be calculated. This may be done in one of two ways for example. One manner is to provide a pressure sensor at the bottom part of the separator vessel 12, and a pressure sensor at the top part of the separator vessel 12 (optionally in the gas phase). By determination of the differential pressure in combination with the density of the liquid the liquid level can be derived.

The described separation vessel is further advantageous in that reliable, safe and straightforward start up may be achieved. A start up process may comprise the following steps. Add diesel or a similar heavy hydrocarbon liquid to the separator vessel 12 to a predetermined level; circulate and heat said liquid via the reheating, recycling loop 26 to attain a start up temperature above ambient; start provision of fresh feed to the separator vessel 12.

Start up with higher boiling hydrocarbons, such as paraffins (boiling point >370 °C), as may be sourced from the from the reheater/reboiler 16, may be advantageous because the reheat, recycle loop 26 may heat the liquid to high temperatures such that the start up liquid inside the separator vessel can reach temperatures close to pyrolysis, for example about 350 °C 370 °C, before fresh plastic feedstock is introduced into the separator vessel 12.

Start up with higher boiling hydrocarbons may also assist in protection of pumps, which may otherwise suffer from cavitation if too lighter boiling components are included.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

The following clauses refer to various aspects of the invention.

Clause 0.1: A process for pyrolysis of plastics material, the process comprising the steps of:
heating plastics material to pyrolysis temperature to provide a fluid stream of at least partially pyrolyzed material comprising liquid and gaseous hydrocarbons;
injecting the fluid stream of liquid and gaseous hydrocarbons into a gas-liquid separation vessel in which gaseous and liquid materials diverge, preferably under gravity;
releasing said gaseous material from the separation vessel for processing of the gaseous material to a hydrocarbon product;
amassing said liquid in a bottom portion of the separation vessel and subjecting the liquid to further pyrolysis;
wherein the fluid stream of liquid and gaseous hydrocarbons is injected to generate a swirl or cyclonic fluid flow in the separation vessel.

Clause 0.2: A process according to clause 0.1 wherein injection of the fluid stream is done below the level of accumulated liquid in the separator vessel.

Clause 0.3: A process according to any of clauses 0.1 to 0.2, wherein the plastics material is heated to a pyrolysis temperature from about 360 °C to about 550 °C, preferably from about 390 °C to about 450°C prior to injection into the separation vessel.

Clause 0.4: A process according to any of clauses 0.1 to 0.3, wherein injecting the fluid stream of liquid and gaseous hydrocarbons into the gas-liquid separation vessel comprises injecting the fluid steam substantially tangentially to an inner surface of the separation vessel, preferably wherein the separation vessel has a substantially circular cross-section at least at a point of injection.

Clause 0.5: A process according to any of clauses 0.1 to 0.4, wherein the step of heating plastics material to pyrolysis temperature to provide a stream of pyrolyzed gaseous hydrocarbons, comprises heating plastics material to pyrolysis temperature in one or more heat exchangers, preferably a plurality of heat exchangers arranged in series, so as to provide a stream of at least partially pyrolyzed gaseous material and liquid material.

Clause 0.6: A process according to any of clauses 0.1 to 0.5, further comprising removing amassed liquid material from the separation vessel, reheating said liquid material to pyrolysis temperature and returning it to the separation vessel as a second fluid stream comprising liquid and gaseous hydrocarbons.

Clause 0.7: A process according to clause 0.6, wherein the second fluid stream is injected into the gas-liquid separation vessel separately, and the gaseous and liquid materials diverge.

Clause 0.8: A process according to any of clauses 0.6 to 0.7, wherein the second fluid stream of liquid and gaseous hydrocarbons is injected to generate or intensify a swirl or cyclonic fluid flow in the separation vessel.

Clause 0.9: A process according to any of clauses 0.1 to 0.8, wherein the pyrolysis results in solid carbon particles in the fluid streams, and the swirl or cyclonic fluid flow drives said solid carbon particles radially outwardly, preferably whereby the solid particles settle to the base of the process according to any of the preceding clauses.

Clause 0.10: A process according to any of clauses 0.1 to 0.9, comprising providing a plastics material feedstock, wherein the plastics material feedstock comprises polyethylene and/or polypropylene plastics, preferably wherein the sum of polyethylene and polypropylene in the feedstock is at least 50 wt. % by weight of the feedstock, more preferably at least 60 wt. %.

Clause 0.11: A process according to clause 0.10, wherein the feedstock comprises polyvinylchloride plastics, preferably greater than 1 wt. % of polyvinylchloride plastics, more preferably greater than 5 wt. %, or wherein the feedstock comprises polyvinylchloride plastics at less than 5 wt. %, more preferably less than 1 wt. %.

Clause 0.12: A process according to any of clauses 10 to 11, wherein the feedstock comprises polyethylene terephthalate plastics, preferably greater than 3 wt. % of polyethylene terephthalate plastics, more preferably greater than 4 wt. %, or wherein the feedstock comprises less than 4 wt. % of polyethylene terephthalate plastics, more preferably less than 3 wt. %.

Clause 0.13: A process according to any of clauses 10, 11 or 12, wherein the feedstock comprises polystyrene plastics, preferably greater than 1 wt. % of polystyrene plastics, more preferably greater than 5 wt. %, or wherein the feedstock comprises less than 20 wt. % of polystyrene plastics, more preferably less than 5 wt. %.

Clause 0.14: A process for the production of hydrocarbon material comprising the steps of any of clauses 0.1 to 0.13, and the further step of distilling gaseous hydrocarbons in a distillation apparatus to give the hydrocarbon product, preferably wherein the hydrocarbon product comprises butane, propane, kerosene, diesel, fuel oil; light distillates, such as LPG, gasoline, naphtha, or mixtures thereof; middle distillates such as kerosene, jet fuel, diesel, or mixtures thereof; heavy distillates and residuum such as fuel oil, lubricating oils, paraffin, wax, asphalt, or mixtures thereof; or any mixtures thereof; hydrocarbons that are saturated, unsaturated, straight, cyclic or aromatic; non-condensable gases comprising methane, ethane, ethene and/or other small molecules; and mixtures thereof.

Clause 0.15: An apparatus for pyrolyzing waste plastics to one or more hydrocarbon products, preferably at least one or more liquid hydrocarbon products, the apparatus comprising:
a heating device, preferably a heat exchanger, for receiving and heating waste plastic to pyrolysis temperature;
a separator vessel downstream of the heating device, wherein the separator device comprises:
an inlet arranged to receive pyrolysis temperature, gaseous and liquid plastics waste from the heating device,
an upper outlet for exit of gaseous material; and
a lower outlet for exit of liquid material;
wherein the inlet is arranged to inject the gaseous and liquid plastics waste from the heating device to generate a swirl or cyclonic fluid flow in the separation vessel.

Clause 0.16: An apparatus according to clause 0.15, wherein the heating device is configured to heat the waste plastic to a pyrolysis temperature from about 360 °C to about 550 °C, preferably from about 390 °C to about 450 °C.

Clause 0.17: An apparatus according to clause 0.15 or 0.16, wherein said inlet is arranged to inject the gaseous and liquid plastics waste from the heating device substantially tangentially to an inner surface of the separation vessel, preferably wherein the separation vessel has a substantially circular cross-section at least at a point of injection.

Clause 0.18: An apparatus according to any of clauses 0.15 to 0.17, wherein the heating device comprises one or more heat exchangers, preferably tube in shell heat exchangers, more preferably a number of heat exchangers arranged in series.

Clause 0.19: An apparatus according to any of clauses 0.15 to 0.18, wherein the separation vessel is elongate and vertically arranged for pyrolyzed gaseous and liquid materials to diverge under gravity, pyrolyzed gaseous material passing upwardly to the upper outlet and liquid material passing downwardly.

Clause 1.1: A process for pyrolysis of plastics material, the process comprising the steps of:
heating plastics material to pyrolysis temperature to provide a fluid stream of at least partially pyrolyzed material comprising liquid and gaseous hydrocarbons;
passing the fluid stream of liquid and gaseous hydrocarbons into a gas-liquid separation vessel in which gaseous and liquid materials diverge, preferably under gravity;
releasing said gaseous material from the separation vessel for processing of the gaseous material to a hydrocarbon product;
amassing said liquid in a bottom portion of the separation vessel and subjecting the liquid to further pyrolysis;
withdrawing a portion of said amassed liquid material from the separation vessel, heating said withdrawn liquid to pyrolysis temperature and returning it to the separation vessel as a fluid stream comprising liquid and gaseous hydrocarbons;0
wherein the amassed liquid is withdrawn via an outlet internal to the separation vessel, preferably an outlet substantially radially central within the separation vessel.

Clause 1.2: A process according to any clause 1.1, wherein the plastics material is heated to a pyrolysis temperature from about 360 °C to about 550 °C, preferably from about 390°C to about 450 °C prior to provision into the separation vessel.

Clause 1.3: A process according to any of clauses 1.1 to 1.2, wherein the pyrolysis results in solid carbon particles in the separator vessel, and fluids in the separator vessel are controlled to provide a swirl or cyclonic fluid to centrifuge said solid carbon particles radially outwardly.

Clause 1.4: A process according to clause 3, wherein the outlet for withdrawal of the amassed liquid is positioned in a generally central portion of said swirl or cyclonic flow.

Clause 1.5: A process according to any of clauses 1.1 to 1.4, wherein a shroud is provided at least partially radially encompassing the liquid outlet, preferably wherein the shroud is partially or fully submerged in the amassed liquid.

Clause 1.6: A process according to clause 1.5, wherein the shroud at least partially isolates the liquid outlet from a radially outer cyclonic or swirling flow in the separation vessel.

Clause 1.7: A process according to any of clauses 1.1 to 1.6, wherein the amassed liquid outlet comprises a vertically arranged cylinder, preferably of circular cross-section, having an opening at its upper end and an opening at its and lower end.

Clause 1.8: A process according to clause 7, wherein the opening at the upper end is smaller than the opening at the lower end.

Clause 1.9: A process according to any of clauses 1.1 to 1.8, wherein the returned fluid stream is injected into the separation vessel to generate or intensify said swirl or cyclonic fluid flow in the separation vessel.

Clause 1.10: A process according to any of clauses 1.1 to 1.9, wherein injection of the fluid stream is done below the level of accumulated liquid in the separator vessel.

Clause 1.11: A process according to any of clauses 1.1 to 1.10, comprising providing a plastics material feedstock, wherein the plastics material feedstock comprises polyethylene and/or polypropylene plastics, preferably wherein the sum of polyethylene and polypropylene in the feedstock is at least 50 wt. % by weight of the feedstock, more preferably at least 60 wt. %.

Clause 1.12: A process according to clause 1.10, wherein the feedstock comprises polyvinylchloride plastics, preferably greater than 1 wt. % of polyvinylchloride plastics, more preferably greater than 5 wt. %, or wherein the feedstock comprises polyvinylchloride plastics at less than 5 wt. %, more preferably less than 1 wt. %.

Clause 1.13: A process according to clause 1.10 or clause 1.11, wherein the feedstock comprises polyethylene terephthalate plastics, preferably greater than 3 wt. % of polyethylene terephthalate plastics, more preferably greater than 4 wt. %, or wherein the feedstock comprises less than 4 wt. % of polyethylene terephthalate plastics, more preferably less than 3 wt. %.

Clause 1.14: A process according to clause 1.10, 1.11 or 1.12, wherein the feedstock comprises polystyrene plastics, preferably greater than 1 wt. % of polystyrene plastics, more preferably greater than 5 wt. %, or wherein the feedstock comprises less than 20 wt. % of polystyrene plastics, more preferably less than 5 wt. %.

Clause 1.15: A process for the production of hydrocarbon material comprising the steps of any of clauses 1.1 to 1.14, and the further step of distilling gaseous hydrocarbons in a distillation apparatus to give the hydrocarbon product, preferably wherein the hydrocarbon product comprises butane, propane, kerosene, diesel, fuel oil; light distillates, such as LPG, gasoline, naphtha, or mixtures thereof; middle distillates such as kerosene, jet fuel, diesel, or mixtures thereof; heavy distillates and residuum such as fuel oil, lubricating oils, paraffin, wax, asphalt, or mixtures thereof; or any mixtures thereof; hydrocarbons that are saturated, unsaturated, straight, cyclic or aromatic; non-condensable gases comprising methane, ethane, ethene and/or other small molecules; and mixtures thereof.

Clause 1.16: An apparatus for pyrolyzing waste plastics to one or more hydrocarbon products, preferably at least one or more liquid hydrocarbon products, the apparatus comprising:
a heating device, preferably a heat exchanger, for receiving and heating waste plastic to pyrolysis temperature;
a separator vessel downstream of the heating device, wherein the separator device comprises:
an inlet arranged to receive pyrolysis temperature, gaseous and liquid plastics waste from the heating device,
an upper outlet for exit of gaseous material; and
a lower outlet for exit of liquid material;
wherein the lower outlet for exit of liquid material is positioned internally in the separation vessel, preferably substantially radially centrally.

Clause 1.17: An apparatus according to clause 1.16, wherein the heating device is configured to heat the waste plastic to a pyrolysis temperature from about 360 °C to about 550°C, preferably from about 390°C to about 450 °C.

Clause 1.18: An apparatus according to clause 1.16 or 1.17, wherein said inlet is arranged to inject the gaseous and liquid plastics waste from the heating device substantially tangentially to an inner surface of the separation vessel, preferably wherein the separation vessel has a substantially circular cross-section at least at a point of injection.

Clause 1.19: An apparatus according to any of clauses 1.16 to 1.18, wherein the separation vessel is elongate and vertically arranged for pyrolyzed gaseous and liquid materials to diverge under gravity, pyrolyzed gaseous material passing upwardly to the upper outlet and liquid material passing downwardly.

Clause 1.20: An apparatus according any of clauses 1.16 to 1.19 wherein the liquid outlet is located below an operational liquid level of the separation vessel and is preferably submerged in use.

Clause 2.1: An apparatus for pyrolyzing waste plastics to one or more hydrocarbon products, preferably at least one or more liquid hydrocarbon products, the apparatus comprising:
a heating device, preferably a heat exchanger, for receiving and heating waste plastic to pyrolysis temperature;
a separator vessel downstream of the heating device, wherein the separator vessel comprises:
an inlet arranged to receive pyrolysis temperature, gaseous and liquid plastics waste from the heating device,
an upper outlet for exit of gaseous material; and
a hollow body with a bottom portion that is substantially conical;
wherein the substantially conical bottom portion has an opening angle is from about 30° to about 70°.

Clause 2.2: An apparatus according to clause 2.1, wherein the opening angle is from about 50° to about 70°, preferably from about 55° to about 65°, more preferably about 60°.

Clause 2.3: An apparatus according to any of clauses 2.1 to 2.2, wherein the separation vessel has one or more inner walls having a surface roughness less than Ra 25 μm, preferably less than Ra 15 μm, more preferably less than Ra 12 μm, even more preferably less than Ra 10 μm.

Clause 2.4: An apparatus according to any of clauses 2.1 to 2.3, wherein the inlet is configured to allow material to enter the separation vessel tangentially.

Clause 2.5: An apparatus according to clause 2.4, wherein the inlet is configured to allow material to enter the separation vessel with a velocity sufficiently high to achieve a swirling or cyclonic motion of the material in the separation vessel.

Clause 2.6: An apparatus according to any of clauses 2.1 to 2.5, wherein the bottom part of the separation vessel comprises an outlet arranged to allow material to exit the separation vessel, preferably a carbon discharge outlet.

Clause 2.7: An apparatus according to any of clauses 2.1 to 2.6, wherein the system is configured to heat the material.

Clause 2.8: An apparatus according to any of clauses 2.1 to 2.7, wherein the system is configured to allow material that has exited the separation vessel via an outlet to circulate back into the separation vessel via an inlet.

Clause 2.9: A process for pyrolysis of plastics material, the process comprising the steps of:
heating plastics material to pyrolysis temperature to provide a fluid stream of at least partially pyrolyzed material comprising liquid and gaseous hydrocarbons, and solid carbon particles;
passing the fluid stream into a gas-liquid separation vessel in which gaseous and liquid materials diverge, preferably under gravity;
releasing said gaseous material from the separation vessel for processing of the gaseous material to a hydrocarbon product;
amassing said liquid, including entrained solid carbon particles in a bottom portion of the separation vessel and subjecting the liquid to further pyrolysis with further generation of solid carbon particles;
settling said solid carbon particles to a bottom portion of the separation vessel, wherein the bottom portion is substantially conical, and the substantially conical bottom portion has an opening angle is from about 30° to about 70°; and
withdrawing at least a portion of a hydrocarbon and solid carbon particle mixture from the bottom conical portion.

Clause 2.10: A process according to clause 2.9, wherein the plastics material is heated to a pyrolysis temperature from about 360 °C to about 550 °C, preferably from about 390°C to about 450 °C prior to provision into the separation vessel.

Clause 2.11: A process according to clause 2.9 or 2.10 wherein the pyrolysis results in solid carbon particles in the separator vessel, and fluids in the separator vessel are controlled to provide a swirl or cyclonic fluid to centrifuge said solid carbon particles radially outwardly.

Clause 2.12: A process according to any of clauses 2.9 to 2.11, carried out with an apparatus in accordance with any of clauses 2.1 to 2.8.

Clause 2.13: A process for the production of hydrocarbon material comprising the steps of any of the clauses 2.9 to 2.12, and the further step of distilling gaseous hydrocarbons in a distillation apparatus to give the hydrocarbon product, preferably wherein the hydrocarbon product comprises butane, propane, kerosene, diesel, fuel oil; light distillates, such as LPG, gasoline, naphtha, or mixtures thereof; middle distillates such as kerosene, jet fuel, diesel, or mixtures thereof, heavy distillates and residuum such as fuel oil, lubricating oils, paraffin, wax, asphalt, or mixtures thereof; or any mixtures thereof; hydrocarbons that are saturated, unsaturated, straight, cyclic or aromatic; non-condensable gases comprising methane, ethane, ethene and/or other small molecules; and mixtures thereof.

Clause 3.1: A process for pyrolysis of plastics material, the process comprising the steps of:
heating plastics material to pyrolysis temperature to provide a fluid stream of at least partially pyrolyzed material comprising liquid and gaseous hydrocarbons;
passing the fluid stream of liquid and gaseous hydrocarbons into a gas-liquid separation vessel in which gaseous and liquid materials diverge, preferably under gravity;
releasing said gaseous material from the separation vessel for processing of the gaseous material to a hydrocarbon product;
amassing said liquid in a bottom portion of the separation vessel and subjecting the liquid to further pyrolysis; and
determining a liquid level in the separation vessel by radar measurement, radioactive measurement, temperature measurement, mass measurement, and/or pressure measurement.

Clause 3.2: A process according to clause 3.1, wherein liquid level in the separation vessel is controlled by adjustment of a rate of pyrolysis, preferably by temperature control.

Clause 3.3: A process according to any of clauses 3.1 to 3.to any preceding clause, wherein liquid level in the separation vessel is controlled by rate of introduction of a fresh feed.

Clause 3.4: A process according to any of clauses 3.1 to 3.3, wherein the liquid level in the separation vessel is maintained at a predetermined level.

Clause 3.5: A process for the production of hydrocarbon material comprising the steps of any of the clauses 3.1 to 3.5, and the further step of distilling gaseous hydrocarbons in a distillation apparatus to give the hydrocarbon product, preferably wherein the hydrocarbon product comprises butane, propane, kerosene, diesel, fuel oil; light distillates, such as LPG, gasoline, naphtha, or mixtures thereof; middle distillates such as kerosene, jet fuel, diesel, or mixtures thereof, heavy distillates and residuum such as fuel oil, lubricating oils, paraffin, wax, asphalt, or mixtures thereof, or any mixtures thereof; hydrocarbons that are saturated, unsaturated, straight, cyclic or aromatic; non-condensable gases comprising methane, ethane, ethene and/or other small molecules; and mixtures thereof.

Clause 3.6: An apparatus for pyrolyzing waste plastics to one or more hydrocarbon products, preferably at least one or more liquid hydrocarbon products, the apparatus comprising:
a heating device, preferably a heat exchanger, for receiving and heating waste plastic to pyrolysis temperature;
a separator vessel downstream of the heating device, wherein the separator vessel comprises:
an inlet arranged to receive pyrolysis temperature, gaseous and liquid plastics waste from the heating device,
an upper outlet for exit of gaseous material; and
a liquid level measurement system for determining liquid level in the separation vessel, the liquid level measurement system comprising one, more or all of the devices chosen from the group of radar measurement, radioactive measurement, temperature measurement, mass measurement, and differential pressure measurement.

Clause 3.7: An apparatus according to clause 3.6, wherein the liquid level inside the vessel is measured using at least two, preferably three, devices.

Clause 3.8: An apparatus according to clause 3.6 or 3.7, wherein the liquid level inside the vessel is measured using a device chosen from the group of guided wave radar measurement, external radioactive level measurement, differential pressure measurement and multipoint temperature measurement.

Clause 3.9: An apparatus according to any of clauses 3.6 to 3.8, wherein the system is configured to control the liquid level inside the vessel.

Clause 3.10: An apparatus according to any of clauses 3.6 to 3.9, wherein the system is further configured to control the pressure inside the vessel.

Clause 3.11: An apparatus according to any of clauses 3.9 to 3.10, wherein the apparatus controls the liquid level inside the vessel by controlling an input rate of fresh feed material that enters the separation vessel and/or controlling an output rate of material that exits the vessel via an outlet as gas, liquid or purge.

Clause 3.12: An apparatus according to any of clauses 3.9 to 3.10, wherein the apparatus controls the liquid level inside the separation vessel by controlling the inflow rate and/or temperature of material inside the vessel.

Clause 4.1: A process for pyrolysis of plastics material, the process comprising the steps of:
heating plastics material to pyrolysis temperature to provide a fluid stream of at least partially pyrolyzed material comprising liquid and gaseous hydrocarbons, and solid carbon particles;
passing the fluid stream into a gas-liquid separation vessel in which gaseous and liquid materials diverge, preferably under gravity;
releasing said gaseous material from the separation vessel for processing of the gaseous material to a hydrocarbon product;
amassing said liquid, including entrained solid carbon particles in a bottom portion of the separation vessel and subjecting the liquid to further pyrolysis with further generation of solid carbon particles;
settling said solid carbon particles to a bottom portion of the separation vessel; and
withdrawing at least a portion of a hydrocarbon and solid carbon particle mixture from the bottom portion of the separation vessel, and recirculating said hydrocarbon and solid carbon particle mixture to said bottom portion.

Clause 4.2: A process according to clause 4.1, wherein the plastics material is heated to a pyrolysis temperature from about 360 °C to about 550 °C, preferably from about 390 °C to about 450 °C prior to injection into the separation vessel.

Clause 4.3: A process according to any of clauses 4.1 to 4.2, wherein fluids in the separator vessel are controlled to provide swirl or cyclonic fluid streams to centrifuge said solid carbon particles radially outwardly.

Clause 4.4: A process according to any of clauses 4.1 to 4.3, wherein in the step of withdrawing and recirculating said hydrocarbon and solid carbon particle mixture, the hydrocarbon and solid carbon particle is withdrawn from the bottom of the separation vessel and is recirculated and injected into the separation vessel at a position, wherein that position is above the bottom withdrawal point and below the liquid level in the separator vessel, preferably below an outlet for withdrawing a portion of said amassed liquid material that has a lower concentration of solid particles, from the separation vessel.

Clause 4.5: A process according to any preceding clause, further comprising the step of determining a characteristic of the withdrawn hydrocarbon and solid carbon particle mixture, preferably a contents mixture, more preferably a characteristic indicative of a coke, char or solid particle concentration or particle size.

Clause 4.6: The process according to clause 4.5, wherein the step of determining the contents of the mixture comprises any one or more of a density analysis, turbidity analysis, viscosity analysis, spectrometer analysis, radioactive analysis and/or ultrasound analysis.

Clause 4.7: A process according to any of clauses 4.1 to 4.6, wherein a ratio of withdrawn mixture to returned mixture is determined based on analysis of one or characteristics of the mixture, optionally wherein a portion of the withdrawn mixture is discharged, more preferably purged, preferably wherein said one or more characteristics is indicative of a concentration or size of solid carbon particles in said mixture.

Clause 4.8: A process according to any of clauses 4.1 to 4.7, comprising the step of heating the mixture during recirculation outside the separation vessel.

Clause 4.9: A process according to any of clauses 4.1 to 4.8, comprising providing a plastics material feedstock, wherein the plastics material feedstock comprises polyethylene and/or polypropylene plastics, preferably wherein the sum of polyethylene and polypropylene in the feedstock is at least 50 wt. % by weight of the feedstock, more preferably at least 60 wt. %.

Clause 4.10: A process according to clause 4.9, wherein the feedstock comprises polyvinylchloride plastics, preferably greater than 1 wt. % of polyvinylchloride plastics, more preferably greater than 5 wt. %, or wherein the feedstock comprises polyvinylchloride plastics at less than 5 wt. %, more preferably less than 1 wt. %.

Clause 4.11: A process according to clause 4.9 or clause 4.10, wherein the feedstock comprises polyethylene terephthalate plastics, preferably greater than 3 wt. % of polyethylene terephthalate plastics, more preferably greater than 4 wt. %, or wherein the feedstock comprises less than 4 wt. % of polyethylene terephthalate plastics, more preferably less than 3 wt. %.

Clause 4.12: A process according to clause 4.10, 4.11 or 4.12, wherein the feedstock comprises polystyrene plastics, preferably greater than 1 wt. % of polystyrene plastics, more preferably greater than 5 wt. %, or wherein the feedstock comprises less than 20 wt. % of polystyrene plastics, more preferably less than 5 wt. %.

Clause 4.13: A process for the production of hydrocarbon material comprising the steps of any of clauses 4.1 to 4.12, and the further step of distilling hydrocarbons in a distillation apparatus to give the hydrocarbon product, preferably wherein the hydrocarbon product comprises butane, propane, kerosene, diesel, fuel oil; light distillates, such as LPG, gasoline, naphtha, or mixtures thereof; middle distillates such as kerosene, jet fuel, diesel, or mixtures thereof; heavy distillates and residuum such as fuel oil, lubricating oils, paraffin, wax, asphalt, or mixtures thereof; or any mixtures thereof, hydrocarbons that are saturated, unsaturated, straight, cyclic or aromatic; non-condensable gases comprising methane, ethane, ethene and/or other small molecules; and mixtures thereof.

Clause 4.14: An apparatus for pyrolyzing waste plastics to one or more hydrocarbon products, preferably at least one or more liquid hydrocarbon products, the apparatus comprising:
a heating device, preferably a heat exchanger, for receiving and heating waste plastic to pyrolysis temperature;
a separator vessel downstream of the heating device, wherein the separator device comprises:
an inlet arranged to receive pyrolysis temperature, gaseous and liquid plastics waste from the heating device,
an upper outlet for exit of gaseous material;
a carbon outlet at the base of the separator vessel for withdrawal of a hydrocarbon and solid carbon particle mixture from a bottom portion of the separation vessel;
one or more recirculation nozzles positioned at the bottom portion of the separation vessel for injection of at least a portion of said withdrawn mixture to the separation vessel.

Clause 4.15: An apparatus according to clause 14, wherein the heating device is configured to heat the waste plastic to a pyrolysis temperature from about 360 °C to about 550 °C, preferably from about 390 °C to about 450 °C.

Clause 4.16: An apparatus according to any of clauses 4.14 to 4.15, further comprising a sample point or station for determination of a characteristic of the withdrawn mixture, preferably a characteristic indicative of a concentration or size of solid carbon particles in said mixture.

Clause 4.17: An apparatus according to clause 4.16, further comprising at least one sensor selected from a density sensor, a turbidity sensor, a flow sensor, a spectrometer, a radioactive sensor, and/or an ultrasound sensor.

Clause 4.18: An apparatus according to any of clauses 4.14 to 4.18, wherein the separation vessel is elongate and vertically arranged for pyrolyzed gaseous and liquid materials to diverge under gravity, pyrolyzed gaseous material passing upwardly to the upper outlet and liquid material passing downwardly.

1. A process for pyrolysis of plastics material, the process comprising the steps of:
heating plastics material to pyrolysis temperature to provide a fluid stream of at least partially pyrolyzed material comprising liquid and gaseous hydrocarbons;
injecting the fluid stream of liquid and gaseous hydrocarbons into a gas-liquid separation vessel in which gaseous and liquid materials diverge, preferably under gravity;
releasing said gaseous material from the separation vessel for processing of the gaseous material to a hydrocarbon product;
amassing said liquid in a bottom portion of the separation vessel and subjecting the liquid to further pyrolysis;
wherein the fluid stream of liquid and gaseous hydrocarbons is injected to generate a swirl or cyclonic fluid flow in the separation vessel.

2. A process according to claim 1, wherein injection of the fluid stream is done below the level of accumulated liquid in the separator vessel.

3. A process according to claim 1, wherein the plastics material is heated to a pyrolysis temperature from about 360 °C to about 550 °C, preferably from about 390 °C to about 450 °C prior to injection into the separation vessel.

4. A process according to claim 1, wherein injecting the fluid stream of liquid and gaseous hydrocarbons into the gas-liquid separation vessel comprises injecting the fluid steam substantially tangentially to an inner surface of the separation vessel, preferably wherein the separation vessel has a substantially circular cross-section at least at a point of injection.

5. A process according to claim 1, wherein the step of heating plastics material to pyrolysis temperature to provide a stream of pyrolyzed gaseous hydrocarbons, comprises heating plastics material to pyrolysis temperature in one or more heat exchangers, preferably a plurality of heat exchangers arranged in series, so as to provide a stream of at least partially pyrolyzed gaseous material and liquid material.

6. A process according to claim 1, further comprising removing amassed liquid material from the separation vessel, reheating said liquid material to pyrolysis temperature and returning it to the separation vessel as a second fluid stream comprising liquid and gaseous hydrocarbons.

7. A process according to claim 6, wherein the second fluid stream is injected into the gas-liquid separation vessel separately, and the gaseous and liquid materials diverge.

8. A process according to claim 6, wherein the second fluid stream of liquid and gaseous hydrocarbons is injected to generate or intensify a swirl or cyclonic fluid flow in the separation vessel.

9. A process according to claim 1, wherein the pyrolysis results in solid carbon particles in the fluid streams, and the swirl or cyclonic fluid flow drives said solid carbon particles radially outwardly, preferably whereby the solid particles settle to the base of the process according to any of the preceding claims.

10. A process according to claim 1 comprising providing a plastics material feedstock, wherein the plastics material feedstock comprises polyethylene and/or polypropylene plastics, preferably wherein the sum of polyethylene and polypropylene in the feedstock is at least 50 wt. % by weight of the feedstock, more preferably at least 60 wt. %.

11. A process according to claim 10, wherein the feedstock comprises polyvinylchloride plastics, preferably greater than 1 wt. % of polyvinylchloride plastics, more preferably greater than 5 wt. %, or wherein the feedstock comprises polyvinylchloride plastics at less than 5 wt. %, more preferably less than 1 wt. %.

12. A process according to claim 10, wherein the feedstock comprises polyethylene terephthalate plastics, preferably greater than 3 wt. % of polyethylene terephthalate plastics, more preferably greater than 4 wt. %, or wherein the feedstock comprises less than 4 wt. % of polyethylene terephthalate plastics, more preferably less than 3 wt. %.

13. A process according to claim 10, wherein the feedstock comprises polystyrene plastics, preferably greater than 1 wt. % of polystyrene plastics, more preferably greater than 5 wt. %, or wherein the feedstock comprises less than 20 wt. % of polystyrene plastics, more preferably less than 5 wt. %

14. A process for the production of hydrocarbon material comprising the steps of claim 1, and the further step of distilling gaseous hydrocarbons in a distillation apparatus to give the hydrocarbon product, preferably wherein the hydrocarbon product comprises butane, propane, kerosene, diesel, fuel oil; light distillates, such as LPG, gasoline, naphtha, or mixtures thereof; middle distillates such as kerosene, jet fuel, diesel, or mixtures thereof; heavy distillates and residuum such as fuel oil, lubricating oils, paraffin, wax, asphalt, or mixtures thereof; or any mixtures thereof; hydrocarbons that are saturated, unsaturated, straight, cyclic or aromatic; non-condensable gases comprising methane, ethane, ethene and/or other small molecules; and mixtures thereof.

15. An apparatus for pyrolyzing waste plastics to one or more hydrocarbon products, preferably at least one or more liquid hydrocarbon products, the apparatus comprising:
a heating device, preferably a heat exchanger, for receiving and heating waste plastic to pyrolysis temperature;
a separator vessel downstream of the heating device, wherein the separator device comprises:
an inlet arranged to receive pyrolysis temperature, gaseous and liquid plastics waste from the heating device,
an upper outlet for exit of gaseous material; and
a lower outlet for exit of liquid material;
wherein the inlet is arranged to inject the gaseous and liquid plastics waste from the heating device to generate a swirl or cyclonic fluid flow in the separation vessel.

16. An apparatus according to claim 15, wherein the heating device is configured to heat the waste plastic to a pyrolysis temperature from about 360 °C to about 550 °C, preferably from about 390 °C to about 450 °C.

17. An apparatus according to claim 15, wherein said inlet is arranged to inject the gaseous and liquid plastics waste from the heating device substantially tangentially to an inner surface of the separation vessel, preferably wherein the separation vessel has a substantially circular cross-section at least at a point of injection.

18. An apparatus according to claim 15, wherein the heating device comprises one or more heat exchangers, preferably tube in shell heat exchangers, more preferably a number of heat exchangers arranged in series.

19. An apparatus according to claim 15, wherein the separation vessel is elongate and vertically arranged for pyrolyzed gaseous and liquid materials to diverge under gravity, pyrolyzed gaseous material passing upwardly to the upper outlet and liquid material passing downwardly.
